(19) United States
(12) Patent Application Publication
(10) Pub. No.: US 2026/0208117 A1
(43) Pub. Date: Jul. 23, 2026

(54) ULTRAFAST WATER FLUX THROUGH HOT-PRESSED SOLUTION BLOWN SPUN NANOFIBER-BASED THIN FILM COMPOSITE MEMBRANES FOR FORWARD OSMOSIS

(71) Applicant: QATAR UNIVERSITY, Doha (QA)

(72) Inventors: Syed Javaid ZAIDI, Doha (QA); Hammadur Rahman SIDDIQUI, Doha (QA); Haleema SALEEM, Doha (QA); Nada Mahmoud ABOUNAHIA, Doha (QA); Levent TRABZON, Istanbul (TR); Ali KILIC, Istanbul (TR)

(21) Appl. No.: 19/377,365

(22) Filed: Nov. 3, 2025

Related U.S. Application Data
(62) Division of application No. 18/115,350, filed on Feb. 28, 2023.
(60) Provisional application No. 63/314,648, filed on Feb. 28, 2022.
(60) Provisional application No. 63/314,661, filed on Feb. 28, 2022.
(60) Provisional application No. 63/314,663, filed on Feb. 28, 2022.

(51) Int. Cl. B01D 67/00; B01D 61/00; B01D 69/12; B01D 71/02; B01D 71/48; B01D 71/56; B01D 71/68; B32B 5/02; B32B 27/12; B32B 27/36; B32B 37/24; B32B 38/00; C02F 1/44; D01D 5/00; D04H 1/4326; D04H 1/728

(52) U.S. Cl. CPC B01D 67/0002; B01D 61/002; B01D 67/0083; B01D 67/0086; B01D 67/00933; B01D 69/1213; B01D 69/1214; B01D 69/1216; B01D 69/1251; B01D 71/024; B01D 71/48; B01D 71/56; B01D 71/68; B32B 5/022; B32B 27/12; B32B 27/36; B32B 37/24; B32B 38/0012; C02F 1/445; D01D 5/0038; D01D 5/0084; D04H 1/4326; D04H 1/728; B01D 2323/081; B32B 2037/243; B32B 2038/0052; B32B 2255/02; B32B 2255/26; B32B 2262/02; B32B 2305/28; B32B 2307/538; B32B 2307/54; B32B 2367/00; B32B 2377/00; B32B 2386/00; D10B 2331/30; D10B 2401/063; D10B 2505/04

(57) ABSTRACT

Described herein are polysulfone-based and polyether sulfone-based thin-film nanocomposite (TFNC) membranes produced by solution blow spinning (SBS) technology for forward osmosis applications, including desalination and wastewater treatment. These TFNC membranes exhibit ultra-fast water flux, low reverse salt flux, and fouling resistance.

### CROSS-REFERENCE TO RELATED APPLICATIONS

This application claims priority to, and the benefit of, U.S. Ser. No. 63/314,648 filed Feb. 28, 2022; U.S. Ser. No. 63/314,661 filed Feb. 28, 2022; and, U.S. Ser. No. 63/314,663 filed Feb. 28, 2022. These applications are incorporated in their entirety by reference for all purposes.

### TECHNICAL INVENTION

Described herein are polysulfone-based and polyether sulfone-based thin-film nanocomposite (TFNC) membranes produced by solution blow spinning (SBS) technology for forward osmosis applications, including desalination and wastewater treatment. These TFNC membranes exhibit ultra-fast water flux, low reverse salt flux, and fouling resistance.

### BACKGROUND OF THE INVENTION

One approach to produce fresh water is desalination. Forward osmosis is a developing membrane-based technology with a wide range of potential water treatment applications, including desalination. The forward osmosis process, which has received considerable attention in the desalination industry, has advantageous elements for sustainable desalination. The process utilizes an osmotic pressure difference produced by the solute concentration difference between a feed solution and a draw solution across a semipermeable membrane. Forward osmosis membranes are an efficient substitute to conventional techniques, such as reverse osmosis and nanofiltration, particularly in seawater desalination and wastewater treatment. Compared to reverse osmosis, forward osmosis uses less total energy consumption and exhibits an improved fouling resistance to various contaminants. Moreover, reverse osmosis requires higher energy (i.e., greater pressure) to drive water from the feed solution side to the draw solution side compared to forward osmosis, and therefore a lower pressure circulation system is adequate for forward osmosis. This low-pressure requirement of the forward osmosis operation reduces the fouling propensity of the membrane and reduces the mechanical strength necessity of the membrane. An effective forward osmosis membrane should have high water permeability, decreased internal concentration polarization, high selectivity, high stability, and high mechanical strength.

Standard membranes employed in the forward osmosis process have a thin-film composite (TFC) structure. The topmost selective barrier layer is a cross-linked aromatic polyamide, while the second and third support layers are polyester-based fabric layers.

Despite all the benefits of forward osmosis technology, reverse solute flux (RSF) is an ongoing important challenge. RSF can lead to problems, including a reduced concentration gradient and draw solution loss. Therefore, the support layer for the forward osmosis process needs to be an extremely porous substrate to minimize concentration polarization, reduce resistance to mass transfer, and improve water flux.

Support layer porosity, thickness, tortuosity, and hydrophilicity all play a crucial role in water flux performance across asymmetric semipermeable membranes. To overcome the current problems in forward osmosis membranes and to further improve the forward osmosis membrane performance (i.e., improve water flux and reduce RSF), highly porous and highly hydrophilic nanofibrous substrates can be used. Nanofibers are ideal for membrane-based separation technology; they are characterized by submicron pore sizes, higher porosity, and larger surface area to volume ratio. These characteristics are also advantageous for low production costs and simply tailored membrane thickness.

Nanofibers are complex fibrous networks with nanoscale diameter that possess high porosities and well-connected pore structures. Various types of nanofibers exist, such as polymer nanofibers, carbon nanofibers, metal oxide nanofibers, organic and inorganic nanofibers, and conducting and semiconducting nanofibers. Polymeric nanofibers are most commonly used for fabricating nanofiber membranes due to their high surface area, their lightweight, and interconnected porous structure. Polymeric nanofibers have been utilized in a variety of water/liquid applications (including ultrafiltration, nanofiltration, microfiltration, reverse osmosis, membrane distillation, oil/water separation, and bio-separation), aerosol filtration, battery separators, textile membranes, protective clothing and protective masks.

Different polymers such as polyether sulfone (PES), polysulfone (PSF), polyvinylidene fluoride (PVDF), polyacrylonitrile (PAN), and cellulose acetate are typically employed in the preparation of nanofiber membranes (NFMs). Among these polymers, PSF is widely used in the fabrication of membranes due to its superior properties, including, thermal stability, mechanical stability, and chemical resistance. Because of their high specific surface area, PSF-based NFMs are considered a superior media for filtration applications. PES, which can exhibit superior mechanical properties, excellent environmental resistance, exceptional thermo-oxidative, and thermal stability, has also been studied.

Nanofibers produced by the standard electrospinning technique are common, however, their use is widely associated with equipment process and safety issues (for example, a high voltage supply of up to 60 kV is required). Additionally, conventional electrospinning techniques require a definite conductivity of the polymeric solution, which can impede the spinnability of various non-conductive polymers, and the solvents compatible with electrospinning are restricted by their dielectric constant. Further, electrospinning techniques often produces nanofibers in a lower yield, making bulk and commercial scale production challenging.

Melt blowing, a different technique to make nonwoven webs, has been shown to be scalable for the fiber industrial production. This process can be controlled to produce fibers in the range of 1 to 50 micrometers diameter. However, the melt blowing technology is not able to prepare fibers with the same diameter range as electrospun fibers and this technique is restricted to thermoplastic polymers. Another technique, melt spinning, also has certain drawbacks. For example, the diameter of fibers prepared using this technology is normally greater than 2 micrometers, and the process is limited to viscoelastic materials that can tolerate the stresses formed at the time of the drawing process.

The solution blow spinning (SBS) method, developed as an alternative technique to consolidate the elements of melt blowing and electrospinning technologies, is an advanced nanofiber manufacture method that is superior to other standard nanofiber manufacture methods. SBS overcomes the low production rate of electrospinning technology and the limited choice of material for melt blowing. It also has a smaller voltage requirement (and is therefore safer) and requires a short preparation time. Further, because there is no conductivity requirement, a wider range of polymers are available in SBS. Polymers that are soluble in volatile and non-toxic solutions (typically not appropriate for melt blowing) can also be used because the solvent choice is not limited by a dielectric constant. Moreover, as the SBS process employs normal temperature compressed air, it can restrict polymer thermal degradation. The fundamental concept of SBS technology is described in U.S. Pat. No. 8,641,960. This technology can fabricate non-woven webs of nanofibers with diameters similar to those obtained by the ES process. The fiber formation driving force is a high-velocity gas flow, and the spinning solution streams are blown due to the shearing force at the solution/gas interface at the high velocity gas flow.

The SBS technology is advantageous because its fiber production rate is several times higher than the electrospinning process (in certain embodiments, as high as 33.3 times). In the electrospinning method, the production rates of the fibers are in the range of 0.3-3 m./nozzle.h, whereas the SBS provides production rates up to 100 ml/nozzle.h. Thus, SBS technology overcomes the lower productivity of electrospinning and the limited selection of materials in melt blowing technology. While the diameter, pore size, and distribution of nanofibers obtained using SBS technology can be the same as for nanofibers produced using electrospinning, the SBS system simplicity is a benefit.

Nanofiber substrates must satisfy small structural parameters (high porosity, low curvature, and low thickness), higher hydrophilicity (for accelerating the diffusion of water molecules), and mechanical strength (for resisting the crossflow pressure). Further, the deposition of a selective layer on the nanofiber membrane can enhance the retention effect of the membrane as well as increase the selective permeability. Therefore, what are needed are nanofiber membranes prepared by the advantageous SBS technology for desalination that exhibit ultra-high water flux, reduced RSF, and improved physical and structural properties.

### SUMMARY OF THE INVENTION

As described herein, SBS technology was used to prepare PSF-based and PES-based thin-film composite (TFC) and thin-film nanocomposite (TFNC) membranes for forward osmosis applications. The TFNC are characterized by an intermediate support layer of hot-pressed PSF/PES solution blown spun nanofiber membrane and in some embodiments, a top selective graphene oxide (GO)-incorporated polyamide (PA) layer. After nanofiber deposition on a polyester fabric mat, the membranes were hot-pressed to reduce the membrane thickness and to improve morphological properties. After the hot-press treatment, a PA layer is deposited on top of the nanofiber support through an interfacial polymerization process between meta-phenylene diamine and trimesoyl chloride to develop the thin-film composite (TFC) membrane. Alternatively, a graphene oxide (GO)-incorporated PA layer can be deposited on top of the nanofiber support by interfacial polymerization to form a thin-film nanocomposite (TFNC) membrane.

Polyamide (PA) deposition and graphene oxide (GO) incorporation were confirmed using various characterization techniques, including Fourier transform infrared spectroscopy (FTIR) and X-ray diffraction (XRD) analyses. The TFC and TFNC membranes were also tested in a forward osmosis study to monitor membrane performance. The forward osmosis test results showed ultrafast water flow through the developed membranes with minimal RSF value. The flux values were higher compared to other studies using electrospun nanofiber support in TFC membranes. Further, a long-term experiment (26 L of water transfer in 160 min) was carried out and confirmed no degradation in the membrane. In certain embodiments, the membranes described herein exhibit a significant increase in overall performance and efficiency compared to commercial TFC- and cellulose triacetate-based membranes.

In one embodiment, the method for producing PSF-based and PES-based nanofiber membranes for forward osmosis comprises the following steps: (1) producing a PSF or PES nanofiber support by SBS technology; (2) hot-pressing the PSF or PES nanofiber support; and either (3a) depositing a polyamide (PA) layer on top of the PSF or PES nanofiber support by interfacial polymerization to form a thin-film composite (TFC) membrane; or, (3b) depositing a graphene oxide (GO)-incorporated PA layer on top of the PSF or PES nanofiber support by interfacial polymerization to form a thin-film nanocomposite (TFNC) membrane.

In one embodiment, the method for producing PSF-based and PES-based nanofiber membranes for FO comprises steps: (1) formulating a spinning solution by blending either (a) polysulfone with N-dimethyl formamide (DMF) or (b) polyethersulfone with a N-methyl-2-pyrrolidone/toluene solvent mixture; (2) feeding the PSF or PES solution using a concentric nozzle and subsequently solution blow spinning the PSF or PES fibers; (3) collecting the PSF or PES nanofibers homogeneously on a rotating vacuum collector to afford a nanofiber mat; (4) hot-press post-treating the PSF or PES nanofiber membranes along the polyester backing layer by placing the membranes in between a set of steel plates; (5) separating the steel plates from the hot-press machine and cooling the membranes; and either (6a) depositing a polyamide layer on top of the hot-pressed nanofiber membrane by interfacial polymerization between meta-phenylene diamine and trimesoyl chloride to form a thin film composite (TFC) membrane; or (6b) depositing a graphene oxide-incorporated polyamide layer on top of the hot-pressed nanofiber membrane by interfacial polymerization to form a thin-film nanocomposite (TFNC) membrane.

As described herein, in the heat-press post treatment, the membrane sample is heat-pressed at a specific temperature, pressure, and duration to enhance membrane morphology and properties and to improve membrane physical integrity. Heat-press post-treatment can also enhance water permeation flux of the nanofiber membrane in water treatment applications and reduce contact angle due to the nanofiber compaction. Furthermore, the heat-press treatment can improve chemical stability and reduce the surface roughness and fouling tendency of nanofiber membranes. Thus, in certain embodiments, the hot-press post-treatment results in smaller average pore size, lesser thickness, greater mechanical strength, higher liquid entry pressure, and uniform distribution of the pore size.

Important heat treatment parameters, such as pressing time, temperature, and load, determine the mechanical characteristics and morphology of the modified membranes. Increasing the heat-press temperature increases compaction level and fiber size, however, it can also decrease surface pore size, contact angle and thickness of the membrane. Studies have confirmed that when the membrane starts melting and fusing at a greater heat-press temperature, the surface of the membrane may become less rough, and therefore less hydrophobic. Increasing the temperature can also contribute to an increase in mechanical strength by achieving higher tensile strength and Young's modulus. Moreover, the fiber size of a membrane that has been heat-pressed for a longer time tends to be greater, and hence the surface pore size is lower. Furthermore, as the pressing time increases, porosity, thickness and contact angle of the heat-pressed membrane decreases. Longer heat-press duration significantly improves mechanical characteristics by producing compacted and completely fused fibers.

In certain embodiments, the TFNC membranes produced by the processes described herein exhibit ultra-high water flux, reduced RSF, and improved physical properties. In certain embodiments, the TFNC membranes described herein demonstrate superior morphology, improved mechanical properties, superior water flux, and reverse solute flux compared to conventional PSF-based and PES-based NFMs.

Forward osmosis membranes are often characterized by lower water flux, membrane fouling, and higher reverse solute flux, however, the TFNC membranes described herein, with a nanofiber membrane support layer prepared using the advanced solution blow spinning method exhibit super-fast water flux. Importantly, these SBS nanofibers were prepared using low voltage (0 kV to 20 kV) and low air pressure. Further, the membranes prepared according to the processes described herein exhibit high stability and membrane integrity; after storage for 90 days under wet and dry conditions, the membranes showed good forward osmosis performance in high-saline conditions.

### BRIEF DESCRIPTION OF DRAWINGS

FIG. 1 an image of a solution blown spinning (SBS) system.

FIG. 2 is the mechanical stability analysis of polysulfone-based NFM base samples prepared at various processing conditions as described in Example 1. (Concentrations: (T5—10 wt %), (E1, E2, F1, F2—17 wt %), (A1, B1—20 wt %); Air Pressure: (A1, B1, E2, F1—1.5 bar), (E1, F2—2.0 bar); and, Voltage: (B1, E1, E2—20 kV), (A1, F1, F2—0 kV)). The samples were held at a constant deposition time of 30 minutes and a constant feed rate of 5 ml/h.

FIG. 3 is the mechanical stability analysis of polysulfone-based NFM hot-press post-treated samples prepared at various processing conditions as described in Example 1. (Concentrations: (T5—10 wt %), (E1, E2, F1, F2—17 wt %), (A1, B1—20 wt %); Air Pressure: (A1, B1, E2, F1—1.5 bar), (E1, F2—2.0 bar); and, Voltage: (B1, E1, E2—20 kV), (A1, F1, F2—0 kV). The samples were held at a constant deposition time of 30 minutes and a constant feed rate of 5 ml/h.

FIG. 4 is a comparison of mechanical stability of 20 wt % polysulfone-based NFM samples A1 and B1 before and after hot-press post-treatment as described in Example 1. (Concentrations (A1, B1—20 wt %); Air Pressure: (A1, B1—1.5 bar); and, Voltage: (B1—20 kV), (A1—0 kV)). The samples were held at a constant deposition time of 30 minutes and a constant feed rate of 5 ml/h. Samples A1 and B1 were hot-press post-treated at 150° C. for 10 minutes under a low loading of 0.5 tons/m² to obtain the corresponding A1-t1 and B1-t1.

FIG. 5 is the comparison of mechanical stability of 17 wt % polysulfone-based NFM samples E1, E2, F1, and F2 before and after hot-press post-treatment as described in Example 1. (Concentrations: (E1, E2, F1, F2—17 wt %); Air Pressure: (E2, F1—1.5 bar), (E1, F2—2.0 bar); and, Voltage: (E1, E2—20 kV), (F1, F2—0 kV). The samples were held at a constant deposition time of 30 minutes and a constant feed rate of 5 ml/h. Samples E1, E2, F1, and F2 were hot-press post-treated at 150° C. for 10 minutes under a low loading of 0.5 tons/m² to obtain the corresponding E1-t1, E2-t1, F1-t1, and F2-T1.

FIG. 6 is the thermogravimetric analysis (TGA) of normal polysulfone-based NFM sample T5 and hot-pressed polysulfone-based NFM T5-T1 sample as described in Example 1. Sample T5 was hot-press post-treated at 150° C. for 10 minutes under a low loading of 0.5 tons/m² to obtain the corresponding T5-t1. The lines for T5 and T5-t1 overlap.

FIG. 7 is the differential scanning calorimetry (DSC) analysis of normal polysulfone-based NFM sample T5 and hot-pressed polysulfone-based NFM T5-T1 sample as described in Example 1. Sample T5 was hot-press post-treated at 150° C. for 10 minutes under a low loading of 0.5 tons/m² to obtain the corresponding T5-t1.

FIG. 8 is the contact angle analysis of base and hot-pressed polysulfone-based NFM samples A1, B1, E1, E2, F1, F2 and T5 as described in Example 1. Samples were hot-press post-treated at 150° C. for 10 minutes under a low loading of 0.5 tons/m² to obtain the corresponding A1-t1, B1-t1, E1-t1, E2-t1, F1-t1, F2-t1 and T5-t1 samples. The left bar for each sample is the base sample surface contact angle plots and the right bar for each sample is the smooth surface contact angle plots (hot-pressed sample).

FIG. 9 is the DMA storage modulus of normal polysulfone-based NFM sample T5 and hot-pressed polysulfone-based NFM T5-t1 sample as described in Example 1. Sample T5 was hot-press post-treated at 150° C. for 10 minutes under a low loading of 0.5 tons/m² to obtain the corresponding T5-t1.

FIG. 10 is the mechanical strength assessment of polyethersulfone (PES)-based nanofiber base samples and heat-treated samples prepared at varying processing conditions as described in Example 2. (Concentrations: T1, C2—25 wt % and D1—20 wt %; Voltage: T1, D1—20 kV, C2—0 kV; constant feed rate: 8 ml/h; constant air pressure: 2 bar; and, constant deposition time: 10 minutes).

FIG. 11 is the mechanical stability analysis of PES-based NFM sample T1 heat-pressed at constant load 0.5 tonne/m² varying the temperature and time as described in Example 2. The heat-press post treatment conditions are as described in Table 2-2.

FIG. 12 is the mechanical stability analysis of PES-based NFM sample T1 heat-pressed at constant load 1.0 tonne/m² varying the temperature and time as described in Example 2. The heat-press post treatment conditions are as described in Table 2-3.

FIG. 13 is the mechanical stability analysis of PES-based NFM sample T1 heat-pressed at constant load 2.0 tonne/m² varying the temperature and time as described in Example 2. The heat-press post treatment conditions are as described in Table 2-4.

FIG. 14 is the mechanical stability analysis of PES-based NFM sample T1 heat-pressed at constant temperature 150° C. varying the load and time as described in Example 2. The heat-press post treatment conditions are as described in 2-5.

FIG. 15 is the mechanical stability analysis of PES-based NFM sample T1 heat-pressed at constant temperature 200° C. and constant time 10 mins at varying load as described in Example 2. The heat-press post treatment conditions are as described in Table 2-6.

FIG. 16 is the mechanical stability analysis of PES-based NFM sample T1 heat-pressed at constant temperature 80° C. and constant time 10 mins at varying load as described in Example 2. The heat-press post treatment conditions are as described in Table 2-7.

FIG. 17 is the mechanical stability analysis of PES-base NFM sample T1 heat-pressed at constant load 0.5 tonne/m² and constant time 10 mins at varying temperatures as described in Example 2. The heat-press post treatment conditions are as described in Table 2-8.

FIG. 18 is the mechanical stability analysis of PES-based NFM sample T1 heat-pressed at constant temperature 150° C. and constant load 0.5 tonne/m² at varying time as described in Example 2. The heat-press post treatment conditions are as described in Table 2-9.

FIG. 19 is the mechanical stability analysis of PES-based NFM sample T1 heat-pressed at constant temperature 150° C. and constant time 10 mins at varying load as described in Example 2. The heat-press post treatment conditions are as described in Table 2-10.

FIG. 20 is the mechanical stability analysis of PES-based NFM sample T1 heat-pressed at constant temperature 150° C. and constant time 20 mins at varying load as described in Example 2. The heat-press post treatment conditions are as described in Table 2-11.

FIG. 21 is the mechanical stability analysis of PES-based NFM samples T1 and C2 (with and without voltage) heat-pressed at a constant load 0.5 tonne/m² and a constant time of 10 mins at various temperatures. The heat-press post treatment conditions are as described in Table 2-12.

FIG. 22 is the thermogravimetric Analysis (TGA) of base PES-based NFM sample T1 and heat-pressed PES-based NFM T1-t1 sample as described in Example 2. Sample T1 was heat-press post-treated at 150° C. for 10 minutes under a low loading of 0.5 tons/m² to obtain the corresponding T1-t1.

FIG. 23 is the differential scanning calorimetry (DSC) analysis of base PES-based NFM sample T1 and heat-pressed PES-based NFM T1-t1 sample as described in Example 2. Sample T1 was heat-press post-treated at 150° C. for 10 minutes under a low loading of 0.5 tons/m² to obtain the corresponding T1-t1.

FIG. 24 is the contact angle analysis of base and heat-pressed PES NFM samples T1, C2 and D1 as described in Example 2. All the samples were heat-press post-treated at 150° C. for 10 minutes under a low loading of 0.5 tons/m² to obtain the corresponding heat-pressed samples.

FIG. 25 is the dynamic mechanical analysis (DMA) storage modulus of base PES-based NFM as described in Example 2. Sample T1 was heat-press post-treated at 150° C. for 10 minutes under a low loading of 0.5 tons/m² to obtain the corresponding T1-t1.

FIG. 26 is the water flux of a polyether sulfone (PES)-based NFM sample (T1) and a polysulfone (PSF)-based NFM sample (T5) as described in Example 3.

FIG. 27 is the water flux of a normal polyether sulfone (PES)-based NFM sample (T1) and a normal polysulfone (PSF)-based NFM sample (T5) hot-pressed under two different conditions to afford samples T1-t1, T1-t2, T5-t1, and T5-t2 as described in Example 3. Sample T1-t1 was obtained by hot-press post-treating sample T1 at 150° C. for 10 minutes under a low loading of 0.5 tons/m². Sample T1-t2 was obtained by hot-press post-treating sample T1 at 175° C. for 6 minutes under a low loading of 0.5 tons/m². Sample T5-t1 was obtained by hot-press post-treating sample T5 at 150° C. for 10 minutes under a low loading of 0.5 tons/m². Sample T5-t2 was obtained by hot-press post-treating sample T5 at 175° C. for 6 minutes under a low loading of 0.5 tons/m².

FIG. 28 is the water flux of samples T1-t1-PA and T5-t1-PA, obtained from polyether sulfone (PES)-based NFM sample (T1) and polysulfone (PSF)-based NFM sample (T5), respectively, by 1) hot-pressing under condition t1 (hot-press post-treatment at 150° C. for 10 minutes under a low loading of 0.5 tons/m²), and 2) depositing a polyamide layer as described in Example 3.

FIG. 29 is the water flux of samples T1-t1-PA-GO and T5-t1-PA-GO, obtained from polyether sulfone (PES)-based NFM sample (T1) and polysulfone (PSF)-based NFM sample (T5), respectively, by 1) hot-pressing under condition t1 (hot-press post-treatment at 150° C. for 10 minutes under a low loading of 0.5 tons/m²), and 2) depositing a GO-incorporated polyamide layer as described in Example 3.

FIG. 30 is the water flux of polyether sulfone (PES)-based NFM sample T1, hot-press post-treated samples T1-t1 and T1-t2 (hot-press post-treated at 150° C. (for 10 minutes) and 175° C. (for 6 minutes), respectively, under a low loading of 0.5 tons/m²), polyamide layer deposited sample T1-t1-PA, and GO incorporated polyamide layer deposited sample T1-t1-PA-GO as described in Example 3.

FIG. 31 is the water flux of polyether sulfone (PES)-based NFM sample T5, hot-press post-treated samples T5-t1 and T5-t2 (hot-press post-treated at 150° C. (for 10 minutes) and 175° C. (for 6 minutes), respectively, under a low loading of 0.5 tons/m²), polyamide layer deposited sample T5-t1-PA, and GO incorporated polyamide layer deposited sample T5-t1-PA-GO as described in Example 3.

FIG. 32 is the reverse solute flux of polyether sulfone (PES)-based NFM sample T1, hot-press post-treated samples T1-t1 and T1-t2 (hot-press post-treated at 150° C. (for 10 minutes) and 175° C. (for 6 minutes), respectively, under a low loading of 0.5 tons/m²), polyamide layer deposited sample T1-t1-PA, and GO incorporated polyamide layer deposited sample T1-t1-PA-GO as described in Example 3.

FIG. 33 is the reverse solute flux of polyether sulfone (PES)-based NFM sample T5, hot-press post-treated samples T5-t1 and T5-t2 (hot-press post-treated at 150° C. (for 10 minutes) and 175° C. (for 6 minutes), respectively, under a low loading of 0.5 tons/m²), polyamide layer deposited sample T5-t1-PA, and GO incorporated polyamide layer deposited sample T5-t1-PA-GO as described in Example 3.

FIG. 34 is the water flux (Flux) and reverse solute flux (RSF) of polyether sulfone (PES)-based hot-press post-treated membrane T1-t1 stored in dry conditions for 90 days carried out under high feed volume conditions as described in Example 3.

FIG. 35 is the water flux (Flux) and reverse solute flux (RSF) of polyether sulfone (PES)-based hot-press post-treated and PA layer deposited sample T1-t1-PA stored in dry conditions for 90 days carried out under high feed volume (5000 mL) conditions as described in Example 3.

FIG. 36 is the water flux (Flux) and reverse solute flux (RSF) of polyether sulfone (PES)-based hot-press post-treated and PA layer deposited sample T1-t1-PA stored in wet conditions for 90 days as described in Example 3.

FIG. 37 is the mechanical stability analysis of normal polyether sulfone-based NFM sample T1, polysulfone-based NFM sample T5, hot-pressed polyether sulfone-based NFM sample T1-t1, and hot-pressed polysulfone-based NFM sample T5-t1 as described in Example 3.

FIG. 38 is the thermogravimetric analysis (TGA) of normal polyether sulfone-based NFM sample T1, polysulfone-based NFM sample T5, hot-pressed polyether sulfone-based NFM sample T1-t1, and hot-pressed polysulfone-based NFM sample T5-t1 as described in Example 3.

FIG. 39 is the differential scanning calorimetry (DSC) analysis of normal polyether sulfone-based NFM sample T1, polysulfone-based NFM sample T5, hot-pressed polyether sulfone-based NFM sample T1-t1, and hot-pressed polysulfone-based NFM sample T5-t1 as described in Example 3.

FIG. 40A is the atomic force microscopy (AFM) analysis of normal polyether sulfone-based NFM sample T1 as described in Example 3. Sample T1 was hot-press post-treated at 150° C. for 10 minutes under a low loading of 0.5 tons/m² to obtain the corresponding T1-t1 (FIG. 40B).

FIG. 40B is the atomic force microscopy (AFM) analysis of hot-pressed polyether sulfone-based NFM sample T1-t1 sample as described in Example 3.

FIG. 40C is the atomic force microscopy (AFM) analysis of polysulfone-based NFM sample T5 as described in Example 3. Sample T5 was hot-press post-treated at 150° C. for 10 minutes under a low loading of 0.5 tons/m² to obtain the corresponding T5-t1 (FIG. 40D).

FIG. 40D is the atomic force microscopy (AFM) analysis of hot-pressed polyether sulfone-based NFM sample T5-t1 as described in Example 3.

FIG. 41A is the scanning electron microscope (SEM) analysis of polysulfone-based NFM sample T5 as described in Example 3. Sample T5 was hot-press post-treated at 150° C. for 10 minutes under a low loading of 0.5 tons/m² to obtain the corresponding T5-t1 (FIG. 41B).

FIG. 41B is the scanning electron microscope (SEM) analysis of hot-pressed polysulfone-based NFM sample T5-t1 as described in Example 3.

FIG. 42 is the DMA storage modulus of normal polyether sulfone-based NFM sample T1, polysulfone-based NFM sample T5, hot-pressed polyether sulfone-based NFM sample T1-t1, and hot-pressed polysulfone-based NFM sample T5-t1 as described in Example 3.

FIG. 43 is the Fourier-transform infrared (FTIR) analysis of normal polyether sulfone-based NFM sample T1; polysulfone-based NFM sample T5; polyamide layer deposited samples T1-t1-PA and T5-t1-PA; and, GO incorporated polyamide layer deposited samples T1-t1-PA-GO and T5-t1-PA-GO as described in Example 3.

### DETAILED DESCRIPTION OF THE INVENTION

### Definitions

Forward osmosis (FO): an extensively used separation process employing the osmotic pressure difference generated by the difference in solute concentration between a feed solution and draw solution.

Membrane: a semipermeable barrier that inhibits the direct contact between two homogeneous phases and facilitates the preferential passage of certain species across the structure.

Nanofiber: one-dimensional (1-D) nanomaterial with a diameter in the range about 1-100 nm and a length of about 1000 nm and higher.

Solution Blow Spinning (SBS): a simple nanofiber fabrication technique that uses pressurized gas to produce nanofibers from a polymer solution.

Water Flux: the rate at which water permeates across a membrane typically expressed as volume per area per unit of time.

Described herein are PSF-based and PES-based thin-film nanocomposite (TFNC) membranes for use in forward osmosis. As described herein, the membrane support layers are very thin, highly porous, non-tortuous, and hydrophilic. Common issues associated with forward osmosis membranes include low water flux, membrane fouling, and high reverse solute flux (RSF), but in certain embodiments, the membranes described herein exhibit ultrafast water flow, minimal RSF values, and are highly stable. Also described herein is the use of a hot-press treated polysulfone (PSF) or polyether sulfone (PES)-based solution blown spun nanofiber mat as the supporting layer for a TFNC membrane with a graphene oxide (GO)-incorporated polyamide (PA) layer for forward osmosis applications.

In certain embodiments, the solvent used in the SBS process includes N-methyl-2-pyrrolidone, toluene, N-dimethyl formamide, or combinations thereof. Alternative solvents include dimethylacetamide and dimethyl sulfoxide.

In certain embodiments, the polymer is a sulfonated polyethersulfone, sulfonated polysulfone, or a combination thereof, including, but not limited to, polyether sulfone (PES) or polysulfone (PSF). In certain embodiments, extra optional components can be used in the solution formulations, including, for example, pore formers (maleic acid or polyethylene glycol).

In certain embodiments, the membranes described herein are used for membrane-based water treatment, protective clothing, textile membranes, battery separators, aerosol filtration, and protective masks.

Also described herein is a process for the preparation of PSF/PES nanofiber using SBS technology, the subsequent hot-press treatment to improve the morphology and properties of the membrane, PA selective layer deposition on top of PSF and PES nanofiber support, and incorporation of GO on the PA layer to improve forward osmosis performance. Mechanical properties were tested on samples prepared using different processing parameters such as voltage (0 kV to 20 kV), air pressure, and polymer concentrations. As described herein, the TFNC membranes, prepared using SBS, exhibit extremely higher water flux and minimal RSF values, properties that help to increase the life of the membrane and are advantageous for forward osmosis applications. The TFNC membranes also exhibited good mechanical strength with an improvement in Young's modulus of almost three to four-fold compared to the normal nanofibers. In fact, the membranes prepared as described herein exhibit superior stability; even after storage for 90 days in both wet and dry conditions, the membranes showed good forward osmosis performance under high-saline conditions.

### SBS Polysulfone-Based Nanofiber-Based Membranes

As described herein, nanofibers have great potential in membrane-based filtration technology due to their submicron pore sizes, high porosity, and large surface area-to-volume ratio, which promotes low production costs and simply tailored membrane thickness. Polymer-based nanofiber membranes are an effective separator system since the fabrication process needs a minimal amount of solvents (i.e., they are cost-effective as well as eco-friendly), and the nanoscale polymer network of the membranes provides increased surface areas. The stable fabrication preparation of nano-sized fibers with adjustable pore size and porosity can be accomplished by controlling nanofiber production conditions, such as polymer concentration, feed rate, air pressure, voltage, deposition time.

Different polymers such as polysulfone (PSF), polyether sulfone (PES), polyacrylonitrile, polyvinylidene fluoride, and cellulose acetate are used for the fabrication of nanofiber membranes (NFMs). PSF is extensively employed in the preparation of membranes due to its superior properties, including mechanical stability, thermal stability, and chemical resistance. Because of their high specific surface area, PSF NFMs are considered as one of best medias for filtration applications. As described herein, in certain embodiments, PSF polymer is used for the preparation of a NFM by SBS technology.

Solution blow spinning (SBS) is an efficient alternative to conventional electrospinning (ES) for nanofiber production. As described herein, while an SBS system can overcome the low production rate of ES, certain drawbacks, including low mechanical properties and comparatively bigger pore sizes relative to membranes fabricated by a casting technique can limit the applications of SBS nanofiber membranes (NFMs) for membrane-based water treatment. Also, the robustness of NFMs is not guaranteed because they are susceptible to wetting in long-term operation. Therefore, as described herein, hot-pressing was employed as a post-treatment to improve the mechanical and morphological properties of polysulfone (PSF)-NFMs.

As described herein, based on characterization, including tensile testing, TGA, DSC, AFM, SEM, and contact angle analysis, hot-pressing treatment improved the morphological and mechanical properties of PSF-based SBS-NFMs. Improvement in mechanical strength, membrane thickness, membrane smoothness, thermal stability, average pore size and uniform distribution of pore size was achieved after hot-press treatment of the PSF-based solution blown spun NFMs. Thus, in certain embodiments, the hot-press technique can enhance the morphological and mechanical properties of PSF-based SBS-NFMs and these PSF-based SBS-NFMs have potential for use in membrane-based water treatment applications and in industrial safety masks.

In one aspect, a method to produce polysulfone-based nanofiber membranes with enhanced morphology and increased mechanical properties is provided. In certain embodiments, these membranes with improved morphology and increased mechanical properties can be used for membrane-based water treatment, protective clothing, textile membranes, battery separators, aerosol filtration, and protective masks.

According to one illustrative embodiment as described herein, a method for manufacturing polysulfone-based nanofiber membranes is provided that comprises (1) preparing a spinning solution by mixing polysulfone (PSF) with N-dimethyl formamide (DMF); (2) feeding the PSF solution through a concentric nozzle and solution blow spinning the PSF fibers; (3) collecting the PSF nanofibers uniformly on a rotating vacuum collector to yield a nanofibrous mat; (4) hot-press post treating the PSF nanofibrous membranes to a polyester backing layer by positioning the membranes between a set of steel plates; and, (5) removing the steel plates from the hot-press and cooling.

In one aspect, a PSF-based NFM fabricated by the method described herein is also provided.

In certain embodiments, the hot-pressed PSF-based NFM demonstrates better morphology and improved mechanical properties compared to the base PSF-based NFM that are at risk of damage and have limited life when used in water treatment applications. In certain embodiments, the membranes described herein show a smooth surface after hot-pressing as compared to base samples. Moreover, the hot-press treatment causes a reduction in pore size and an increase in hydrophobicity, which in certain embodiments, is beneficial for membrane-based water treatment filters, protective clothing, textile membranes, battery separators, aerosol filtration and protective masks.

In an alternative embodiment, the polymer is chosen from the group consisting of PES, sulfonated polysulfone, sulfonated polyethersulfone, and mixtures thereof.

In one embodiment, the spinnability of polymer solution can be enhanced by using polymer mixtures. Non-limiting examples of polymers that can be used for a mixture, include, but are not limited to polyvinylidene fluoride (PVDF), polyacrylonitrile (PAN), polyether sulfone (PES), etc. In certain embodiments, the hybrid approach can be also used to enhance surface area and morphology of nanofiber mats. Water soluble polymers or solvents that can be added into the PS solution and extracted later, include, polyvinyl acetate (PVA), polyethylene glycol (PEG), polyvinylpyrrolidone (PVP), N-methyl-2-pyrrolidone (NMP), N-dimethyl formamide (DMF), dimethyl sulfoxide (DMSO), etc.

Further, in one embodiment, nanomaterials are added. In another embodiment, silver or quaternary ammonium salts are added for antibacterial/antimicrobial properties.

As described herein, PSF solutions with three concentrations (10, 17 and 20 wt %) in N-dimethyl formamide were solution blown-spun at varying air pressures (1.5 and 2.0 bar) and voltages (1 and 20 kV) at a constant deposition time (30 minutes) and a feed rate of 5.0 mL/h. The fabricated NFMs were hot-pressed post-treated at 150° C. for 10 minutes under a low loading of 0.5 tongs/m². As described herein, an improvement in morphology and mechanical properties of the hot-pressed NFMs compared to the base samples was observed. For example, the hot-pressed membranes described herein showed a smooth surface after hot-pressing compared to the base samples. Further, the hot-press treatment caused a reduction in pore size and an increase in hydrophobicity. In certain embodiments, the hot-pressed membranes with improved morphology and mechanical properties are used in membrane-based water treatment filters, protective clothing, textile membranes, battery separators, aerosol filtration and protective masks.

Non-limiting embodiments of SBS polysulfone-based nanofiber-based membranes include:

1. A method of manufacturing nanofiber membranes for water treatment applications using the maturing solution blown spinning technology wherein the method comprises:
a. preparing a spinning solution by mixing polysulfone (PSF) with a solvent;
b. feeding the PSF solution through a concentric nozzle and solution blow spinning the PSF fibers at an air pressure of 1.5 or 2.0 bar; a voltage of 0 or 20 kV; a constant deposition time of 30 minutes, and a feed rate of 5.0 ml/h;
c. collecting the PSF nanofibers uniformly on a rotating vacuum collector to yield a nanofibrous mat;
d. hot-press post treating the PSF nanofibrous membranes to the polyester backing layer by positioning the membranes between a set of steel plates at about 150° C. for 10 minutes under a low loading of 0.5 tons/m²; and
e. maintaining the steel plates at room temperature and then taking the PSF NFM samples out from the steel plates to afford mechanically strong and morphologically improved nanofiber membranes.

2. The method of embodiment 1, wherein the polymer is polysulfone (PSF) and the concentration of the polysulfone is about 10 wt %, about 17 wt %, or about 20 wt % by weight of the solvent.

3. The method of embodiment 1 or 2, wherein the polymer concentration is 10 wt % to 30 wt % by weight of the solvent.

4. The method of any one of embodiments 1-4, wherein the solvent is selected from the group consisting of N-dimethyl formamide (DMF), dimethyl sulfoxide (DMSO), dimethylacetamide (DMAc), and N-methyl-2-pyrrolidone (NMP).

5. The method of embodiment 5, wherein the solvent is N-dimethyl formamide (DMF).

6. The method of any one of embodiments 1-6, wherein the polymeric solution comprises nanoparticles such as graphene oxide or carbon nanotubes.

7. The method of any one of embodiments 1-7, wherein the gas for the SBS nanofiber production is selected from the group consisting of air, nitrogen, and mixtures thereof.

8. The method of any one of embodiments 1-8, wherein the polymeric solution deposition time ranges from about 10 minutes to about 30 minutes.

9. The method of any one of embodiments 1-9, wherein the polymeric solution feed rate ranges from about 5 mL/h to about 8 mL/h.

10. The method of any one of embodiments 1-10, wherein the system air pressure ranges from about 1.5 bar to about 3.0 bar.

11. The method of any one of embodiments 1-11, wherein the system voltage ranges from about 0 kV to about 20 kV.

### SBS Polyethersulfone-Based Nanofiber-Based Membranes

Polyethersulfone (PES) is commonly used for membrane fabrication due to its high glass transition temperature, extensive pH range from 1 to 13, outstanding thermal and chemical resistance (good oxidation resistance and resistance to chloride), high hydrolysis stability, and appropriate mechanical strength and stiffness. In comparison to conventional membranes for water treatment, a polyethersulfone nanofiber membrane has a high-water permeability and can effectively remove contaminants. Thus, as described herein, PES polymer made by the SBS method is employed for the fabrication of nanofiber membrane.

The effect of different heat-press post-treatment parameters on polyether sulfone (PES)-based nanofiber membranes (NFMs) fabricated using the solution blow spinning (SBS) technique were studied. In one embodiment, PES solutions with two different concentrations (25 and 20 wt. %) in a N-methyl-2-pyrrolidone/toluene solvent mixture (2:1 wt.) were solution blown spun at an air pressure of 2.0 bar, 5.0 ml/h feed rate, 10 minutes deposition time, and a varying voltage. The NFMs produced using the SBS method demonstrated poor mechanical integrity and required appropriate post-fabrication treatment to improve their mechanical properties. The NFMs were then hot-press post-treated at varying temperatures (80° C., 150° C., 175° C., and 200° C.), using different pressing times (5, 10 and 20 minutes) under varying loads (0.5, 10 and 2.0 tons/m²), and this resulted in improved morphology and mechanical properties. The hot-pressed NFMs also had a smoother surface relative to the base samples. Furthermore, the heat-press post treatment resulted in a decrease in pore size, which is advantageous for different NFM applications, such as water treatment filters, aerosol filtration, battery separators, textile membranes, protective clothing, and protective masks.

In one aspect, a method to manufacture PES-based NFMs with improved morphological characteristics as well as enhanced mechanical properties to make the NFMs suitable for applications, such as water treatment filters, aerosol filtration, battery separators, textile membranes, protective clothing, and protective masks is provided.

In a preferred embodiment, the method for preparing PES-based NFMs comprises (1) producing a polymeric spinning solution by mixing PES with the N-methyl-2-pyrrolidone/toluene solvent mixture (2:1 wt.); (2) passing the PES solution through a concentric nozzle and solution blow spinning the PES nanofibers at the specified processing conditions: (concentrations of 25 and 20 wt. %); air pressure of 2.0 bar; a 5.0 ml/h feed rate; and, a 10 minute deposition time) with varying voltage; (3) collecting the PES nanofibers homogeneously on a rotating vacuum collector to form a polymeric nanofiber mat; (4) heat-press post treating the PSF nanofibrous membranes along with the polyester backing layer by placing the membranes in the middle of a set of steel plates at varying parameters (pressing temperature, pressing time and load); and, (5) removing the heat steel plates from the hot-press and cooling.

In certain embodiments, the heat-pressed PES-based NFM show improved morphological characteristics and superior mechanical properties relative to the base PES-based nanofiber membranes that are susceptible to damage and have limited lifetimes when used in water treatment applications. Moreover, in certain embodiments, the membranes prepared according to the method described herein have a smoother surface subsequent to heat-pressing compared to the base NFM samples. Furthermore, the heat-treatment of NFMs results in a decrease in pore size as well as increase in hydrophobicity, which in certain embodiments, is beneficial when the NFMs are used in water treatment filters, aerosol filtration, battery separators, textile membranes, protective clothing, and protective masks.

Non-limiting embodiments of SBS polyethersulfone-based nanofiber-based membranes include:

1. A method for preparing NFMs for use in water treatment, industrial, and medical safety clothing applications using the solution blown spinning technology wherein the method comprises:
a. formulating a polymeric spinning solution by combining two solutions of different concentrations of PES in a solvent;
b. feeding the PES-based solution across a concentric nozzle of a system and solution blow spinning the PES nanofibers at an air pressure of 2.0 bar; a 5.0 ml/h feed rate; a 10 minute deposition time; and a voltage of 0 or 20 kV;
c. collecting the PES-based nanofibers evenly on a rotating vacuum collector to generate a nanofiber mat;
d. heat-press post-treating the PES-based NFMs together with the polyester backing layer by positioning the membranes in the middle of a set of steel plates at a temperature of 80° C., 150° C., 175° C. or 200° C.; a pressing time of 10 or 20 minutes; and a load of 0.5, 10 or 2.0 tons/m²; and
e. maintaining the steel plates at room temperature and removing the PES-based nanofiber membrane samples from the steel plates to afford morphologically improved and mechanically strong NFMs.

2. The method of embodiment 1, wherein the two solutions of different concentrations of PES are 25 wt % and 20 wt % by weight of the solvent.

3. The method of embodiment 1, wherein the solvent is a mixture of N-methyl-2-pyrrolidone/toluene in a 2:1 ratio by weight.

4. The method of embodiment 1, wherein the concentration of polymer is 10 to 30 wt % by weight of the solvent.

5. The method of embodiment 1, wherein the solvent is chosen from the group consisting of N-methyl-2-pyrrolidone, toluene N-dimethyl formamide, dimethylacetamide (DMAc), and dimethyl sulfoxide (DMSO).

6. The method of embodiment 1, wherein the polymeric solution comprises nanomaterials selected from carbon nanotubes and graphene oxide.

7 The method of embodiment 1, wherein the gas for the solution blow spinning nanofiber production is chosen from the group consisting of air, nitrogen, and mixtures thereof.

8. The method of embodiment 1, wherein the polymeric solution deposition time during the SBS process ranges from about 10 to 30 minutes.

9. The method of embodiment 1, wherein the polymer solution feed rate in the SBS system is in the range of about 5 mL/h to 8 mL/h.

10. The method of embodiment 1, wherein the SBS system air pressure is in the range of about 1.5 bar to 2.0 bar.

11. The method of embodiment 1, wherein the SBS system voltage is in the range of about 0 kV to 20 kV.

### Water Flux Through SBS Nanofiber-Based Thin Film Composite Forward Osmosis Membranes

Also described herein is a method to solve current issues experienced in forward osmosis membranes, such as low water flux and high reverse solute flux (RSF). Advanced thin film composite (TFC) membranes with enhanced permeability and lower RSF values can help to increase the life of the membrane. As described herein, in one embodiment, nanofiber polyether sulfone (PES) or polysulfone (PSF) nanofiber membranes are used as membrane support and a graphene oxide incorporated polyamide layer is used as a selective layer of the membrane. This SBS method is superior to conventional electrospinning for nanofiber production because it has better process control, easier operation, requires significantly less time, and affords better nanofiber distribution. Further, as described herein, prepared nanofiber membrane prepared using the hot-press post treatment exhibited good mechanical strength with a 3- to 4-fold improvement in Young's modulus compared to the base samples. The membranes developed as described herein and stored for 90 days in wet and dry conditions retained their performance in the long-run forward osmosis study under high-saline conditions.

In one aspect, the membranes described are used in the forward osmosis process. Alternatively, the membranes are used in the reverse osmosis process. In certain embodiments, these membranes are used in the dairy and beverage industries.

The membranes prepared as described herein help to solve current issues experienced in forward osmosis membranes, such as lower water flux, membrane fouling, and higher reverse solute flux. In one aspect, the preparation of thin-film nanocomposite membranes with super-fast water flux and a nanofiber membrane support layer prepared using the solution blow spinning method is provided. The membranes prepared as described herein showed good forward osmosis performance in the long-run experiment under high-saline conditions (storage for 90 days both in wet and dry conditions).

Although the nanofibers produced by standard electrospinning technique are widely used in environment, catalysis, and energy fields, standard electrospinning technique can have equipment process issues and safety issues. Additionally, conventional electrospinning technique requires a definite conductivity of the polymeric solution, which impedes the spinnability of various nonconductive polymers. Additionally, the electrospinning technique can produce the nanofibers in a lower yield, which makes bulk production challenging and can impede commercial scale production. For this reason, the innovative SBS technology was developed to achieve high nanofiber productivity and to eliminate safety problems related to the conventional ES process. This SBS technique is a consolidation of melt blowing (MB) and ES techniques, has short preparation time, requires less voltage, and can produce nanofibers in high yields.

Furthermore, the SBS process does not require conductivity and it is amenable to a wider range of polymer solutions, which increases the polymer solution's application range. Additionally, there is no requirement for higher voltage electrostatic field support in this process and therefore, the safety is relatively higher. As compared to the melt blowing technique, SBS can handle a wide source of raw materials and is very suitable for specific polymer raw materials that are soluble in volatile and non-toxic solutions. In certain embodiments, the membranes as described herein can be used in membrane-based water treatment applications, such as forward osmosis.

Described herein is the development of superior performance thin film composite (TFC) nanofiber supported membranes for use in osmotically driven membrane processes, i.e., forward osmosis. The membrane support layers must be very thin, highly porous, non-tortuous, and hydrophilic for applications in forward osmosis process. Certain current issues experienced in forward osmosis membranes, such as low water flux, membrane fouling, and high reverse solute flux (RSF) are not observed with the membranes produced as described herein. As discussed herein, the performance of hot-press treated polysulfone (PSF) or polyether sulfone (PES)-based solution blown spun nanofiber mat as the supporting layer of TFNC membrane and graphene oxide (GO)-incorporated polyamide (PA) layer as the selective layer were investigated for forward osmosis applications. Further, the preparation of PSF or PES nanofibers using the SBS technology and subsequent hot-press treatment in combination with the PA selective layer deposition on top of PSF or PES nanofiber support and incorporation of GO on the PA layer was investigated as a means to improve the morphology and properties of the membrane.

As described herein, high water flux and a minimal RSF values were achieved using solution blown spun nanofiber supported GO-TFC membranes in the forward osmosis process. Therefore, in one aspect, the developed thin-film nanocomposite membranes produced as described herein are used for forward osmosis application.

The membranes prepared according to the present invention and stored for 90 days both in wet and dry conditions showed good forward osmosis performance in the long-run experiment under high-saline conditions.

In certain embodiments, the thin film composite membranes are produced using a method comprising: (1) producing the PSF or PES nanofiber support by SBS technology; (2) hot-pressing the PSF or PES nanofiber support; (3a) depositing a polyamide (PA) layer on top of the PSF or PES nanofiber support by interfacial polymerization to form a thin-film composite (TFC) membrane; or, (3b) depositing a graphene oxide (GO)-incorporated PA layer on top of the PSF or PES nanofiber support by an interfacial polymerization technique to form thin-film nanocomposite (TFNC) membrane. The TFNC membrane with the nanofiber support is used for forward osmosis applications and exhibits ultra-fast water flux, low reverse salt flux, and fouling resistance. The membranes described herein showed significant increase in overall performance and efficiency when compared to commercial TFC and cellulose triacetate (CTA) based membranes. Therefore, in one embodiment, these membranes are used in desalination and wastewater treatment.

As described herein, a forward osmosis membrane was prepared with ultra-high water flux, reduced RSF, and improved physical and structural properties. The FO performance of the prepared nanofiber membranes with an intermediate support layer of hot-pressed PSF or PES solution blown spun nanofiber membrane and a top selective GO-incorporated PA layer was also analyzed.

In one embodiment, the method for manufacturing superior performance PSF-based or PES-based nanofiber FO membranes comprises (1) formulating the spinning solution by blending either (a) polysulfone with N-dimethyl formamide (DMF) or (b) polyethersulfone with N-methyl-2-pyrrolidone/toluene solvent mixture (2:1 wt.); (2) feeding the PSF or PES solution using a concentric nozzle and subsequently solution blow spinning the PSF or PES fibers at specified processing conditions; (3) collecting the PSF or PES nanofibers homogeneously on a rotating vacuum collector to obtain a nanofiber mat; (4) hot-press post treating the PSF or PES nanofiber membranes along with the polyester backing layer by placing the membranes in between a set of steel plates at specific hot-pressing conditions; (5) separating the steel plates from the hot-press machine and cooling; and either (6a) depositing a polyamide layer on top of the hot-pressed nanofiber membrane samples by interfacial polymerization between meta-phenylene diamine and trimesoyl chloride; or, (6b) depositing a graphene oxide-incorporated polyamide layer on top of the hot-pressed nanofiber membrane samples by interfacial polymerization.

The TFNCs can also be tested in a forward osmosis system to analyze the water flux and reverse solute flux values. The structural and mechanical properties of the TFNCs can also be characterized.

The membranes prepared as described herein exhibit ultra-high water flux, reduced RSF, and improved physical properties. The hot-pressed solution blown spun PSF-based or PES-based NFMs demonstrate superior morphology, improved mechanical properties, superior water flux and reverse solute flux compared to the base PSF-based or PES-based NFM, respectively, which are at risk of damage and have limited life while employed in water treatment uses.

Non-limiting embodiments of the membranes and processes for making the membranes described herein include:

1. A method of making solution blown spun, hot-press post-treated structurally improved and mechanically strong polymer nanofiber supported thin film nanocomposite membranes for a forward osmosis process wherein the method comprises:
a. preparing a spinning solution by either (1) mixing 10 wt. % of polysulfone with N-dimethyl formamide (DMF) or (2) mixing 25 wt. % of polyethersulfone with N-methyl-2 pyrrolidone/toluene in a 2:1 ratio;
b. feeding the polymer solution (polysulfone or polyethersulfone) using a concentric nozzle and solution blow spinning the fibers;
c. collecting the polymeric nanofibers evenly on a rotating vacuum collector to obtain a nanofiber mat on a polyester backing layer;
d. hot-press post-treating the polymeric (polysulfone or polyethersulfone) nanofiber membranes by placing the membranes in between a set of steel plates at 150° C. and 175° C. for 10 minutes and 6 minutes, respectively, under a low loading of 0.5 tons/m²;
e. removing the steel plates from the hot-press and cooling;
f. removing the polymeric (polysulfone or polyethersulfone) nanofiber membrane samples from the steel plates to afford mechanically strong and structurally enhanced NFMs;
g. preparing a solution of trimesoyl chloride solution and a solution of m-phenylenediamine for interfacial polymerization process; and either
h1. preparing the thin-film composite membrane by depositing a polyamide layer on top of the polymeric (polysulfone or polyethersulfone) nanofiber membrane sample by an interfacial polymerization process; or
h2. preparing the thin-film nanocomposite membrane by depositing a graphene oxide incorporated polyamide layer on top of the polymeric (polysulfone or polyethersulfone) nanofiber membrane sample by an interfacial polymerization process.

The method of embodiment 1, wherein the polysulfone concentration is 10 wt % of the DMF or the polyethersulfone concentration is 25% wt % of the N-methyl-2 pyrrolidone/toluene mixture.

The method of embodiment 1, in which the polymeric concentration is 5 wt % to 30 wt % by weight of the solvent.

The method of embodiment 1, wherein the polymer solution comprises nanomaterials selected from carbon nanotubes and graphene oxide.

The method of embodiment 1, wherein the gas for the SBS nanofiber production is chosen from a group consisting of air, nitrogen, other inert gases and mixes thereof.

The method of embodiment 1, in which the polymer solution deposition time during SBS process is up to 60 minutes.

The method of embodiment 1, in which the polymer solution feed rate ranges from about 5 mL/h to 25 mL/h during the SBS process.

The method of embodiment 1, in which the air pressure of SBS system ranges from about 1.5 to 2.0 bar.

The method of embodiment 1, in which the air pressure of SBS system is higher than 2.0 bars.

The method of embodiment 1, wherein the voltage of the SBS system ranges from about 0 to 20 kV.

The method of embodiment 1, wherein the voltage of the SBS system is higher than 20 kV.

The method of embodiment 1, wherein the hot-press post treatment of NFMs is carried out at a temperature of about 80° C. to 200° C.

The method of embodiment 1, wherein the hot-press post treatment of NFMs is carried out at a time in the range of about 5-20 minutes.

The method of embodiment 1, wherein the hot-press post treatment of NFMs is carried out at a constant load in the range of about 0.5 to 2.0 tonne/m².

The method of embodiment 1, wherein the concentration of the m-phenylenediamine solution is from about 1 wt. % to 5 wt. % which is obtained by dissolving m-phenylenediamine in DI water.

The method of embodiment 15, wherein the concentration of the trimesoyl chloride solution for interfacial polymerization is about 0.1 wt. % to 0.15 wt. %, which is obtained by dissolving trimesoyl chloride in n-hexane.

The method of embodiment 1, wherein different solvents are used for dissolving the m-phenylenediamine and trimesoyl chloride during the interfacial polymerization process.

The method of embodiment 15 or 16, wherein the nanofiber membranes are immersed in the m-phenylenediamine solution for 2 to 5 minutes and then immersed in the trimesoyl chloride solution for 10 seconds to 60 seconds.

The method embodiment 18, wherein the heating time in the oven is in the range of about 60-110° C. for 90 seconds to 8 minutes after the interfacial polymerization process.

The method of embodiment 1, wherein the graphene oxide concentration is in the range of about 0.006 wt % to 0.06 wt %.

A thin-film nanocomposite membrane prepared according to embodiment 1, wherein different nanomaterials selected from carbon nanotubes, halloysite nanotubes, silver, and titanium dioxide are incorporated into the polyamide of the TFC membrane during interfacial polymerization process.

A thin-film nanocomposite membrane prepared according to embodiment 1, wherein the membrane can be easily tested for a prolonged period in a forward osmosis system with a general wash without any requirement for a back-wash.

A thin-film nanocomposite membrane prepared according to embodiment 1, wherein the membrane shows no indication of practical fouling or decline in performance after 90 days of storing and testing.

A thin-film nanocomposite membrane prepared according to embodiment 1, wherein the membrane performs in a similar way during a forward osmosis study when the forward osmosis study is carried out with magnesium chloride and sodium chloride.

A thin-film nanocomposite membrane prepared according to embodiment 1, wherein the membrane is capable of extracting water from DI water and high-concentrated industrial brine solution during a forward osmosis process.

A thin-film nanocomposite membrane prepared according to embodiment 1, wherein the membrane does not lose performance in forward osmosis after a prolonged period and multiple uses.

A thin-film nanocomposite membrane prepared according to embodiment 1, wherein the membrane functions properly during forward osmosis under a variety of ranges of solution concentrations as well as different flow rates.

A thin-film nanocomposite membrane prepared according to embodiment 1, wherein the membrane performance is consistent during forward osmosis after storage for a prolonged period both in dry state and wet state.

A thin-film nanocomposite membrane prepared according to embodiment 1.

### EXAMPLES

The subsequent examples are described herein to provide those of standard skill in the art with a complete disclosure and description of the composition of the polymer solution, the processing conditions, the hot-pressing post-treatment conditions, and the interfacial polymerization process for the polyamide layer (with and without graphene oxide) deposition on top of the nanofiber support. The different approaches and/or devices described herein are assessed and are aimed to be purely a model of this invention and are not aimed to limit the scope of what the inventors regard relating to the current invention. Several attempts have been made to ensure the precision in relation to numbers (e.g., amounts, temperature, etc.), though minor errors and deviations should be accounted for.

### Example 1. Effect of Processing Conditions and Hot-Press Treatment on the Properties of SBS Polysulfone-Based Nanofiber Membranes

### Materials:

Polysulfone, average Mw~35,000 by LS, average Mn~16,000, was obtained from Sigma Aldrich. N-dimethyl formamide (DMF) was also purchased from Sigma Aldrich.

### SBS Apparatus:

The SBS equipment mainly includes a (1) source of compressed gas; (2) a high voltage power supply; (3) a pressure regulator; (4) a blowing apparatus; and, (5) a collector.

Each of the single holes in the multi-hole spinneret has two concentric channels as concentric fluid flow channels and the PSF spinning solution is extruded through the internal passage while the high-pressure gas-flow is ejected through the external passage. When the spinning solution of the internal passage is extruded at a constant rate, the droplet is stretched to form solution jets under the shearing and drawing action caused by the high-pressure gas-flow at the spinneret and the PSF nanofibers are formed after the solvent evaporated.

The system attenuates fibers under the effect of electrical forces and aerodynamic forces. The coaxial nozzle has a specific geometry, which provides an air-to-polymer jet angle of 10-60° for the smooth flow of polymeric solution. The system is also supported with a high voltage power supply. Single or multi nozzle is mounted on a reciprocating shaft for uniform deposition of nanofibers on a rotating vacuum collector covered with a nonwoven substrate. A high voltage power supply of 20 kV was used along with an air compressor that is capable of supplying air pressure air up to 2 bars. The effective generation of fibers by using SBS technology is dependent on its system parameters (ambient conditions and nozzle geometry), solution parameters (solvent type, concentration, and viscosity), and process parameters (working distance, solution flow rate, gas pressure, and voltage). The rotating vacuum collector or running conveyor is the most suitable collection method for uniform collection of nanofibers. Flat stationary cannot be used as it will change homogeneity.

The solvent can be easily evaporated during fiber formation due to the working distance typically between 30 and 80 cm, but is dependent on the volatility of the solvents. At low nozzle-collector distance (NCD), system tended to produce more droplets, not having enough time to remove the solvent and form fibers. By increasing collection distance, solvent will evaporate. Droplet and bead concentration decreases, allowing a more homogeneous fiber structure to be formed. By further increasing the collection distance, it was observed that less fiber was formed on the collector. It has been observed that with increasing distance, fine fibers are more swept away and collected in different parts of the spinning chamber. The optimum NCD was determined to be 50 cm and the NCD below in Example 1 is 50 cm.

Certain important parameters affect the formation of fibers in the solution blowing system, including the molecular weight, concentration and viscosity of the polymer. In addition to these parameters, the air pressure, voltage, and the feed rate of the polymer solution are important process parameters that affect the fiber formation.

### Nanofiber Preparation Using SBS Technology at Varying Processing Conditions:

The process for the PSF nanofiber membranes via SBS technology is as follows: PSF and N-dimethyl formamide solvent (10 wt %, 17 wt %, and 20 wt % of PSF) were initially mixed and the mixtures were placed in a water bath and stirred properly to obtain the PSF solution. The air pressure of the SBS system was maintained at 1.5 bar and 2.0 bar, while the solution feeding rate was 5 mL/h. The polymer solution was pumped through a 21-gauge needle, which was located inside a concentric nozzle (FIG. 1). The polymer concentration was 10 wt %, 17 wt %, and 20 wt % by weight of the solvent and the deposition time was 30 minutes for the samples. Polymer solutions were solution blown spun at a feed rate of 5.0 ml/h with varying air pressure (1.5 and 2.0 bar) and voltage (0 and 20 kV). The PSF polymer solution was fed through a concentric nozzle. The solution came into contact with compressed air at the nozzle tip and was stretched out with the shear effect created by the air on the way to the vacuum collector to yield a nanofibrous mat. The PSF-based NFM substrates were fabricated according to the polymer concentration and processing conditions provided in Table 1-1. Polyester nonwoven with excellent mechanical property was chosen as the structural support and the PSF nanofiber membranes were deposited on top of this polyester layer during the SBS process.

TABLE 1-1

| | | Solution | | | |
|---|---|---|---|---|---|
| | | Feeding | Air | | Production |
| Sample | Concentration | rate | Pressure | Voltage | time |
| Name | (wt. %) | (mL/h) | (bar) | (kV) | (min) |
| A1 | 20 | 5 | 1.5 | — | 30 |
| B1 | 20 | 5 | 1.5 | 20 | 30 |
| E1 | 17 | 5 | 2.0 | 20 | 30 |
| E2 | 17 | 5 | 1.5 | 20 | 30 |
| F1 | 17 | 5 | 1.5 | — | 30 |
| F2 | 17 | 5 | 2.0 | — | 30 |
| T5 | 10 | 5 | 1.5 | 20 | 30 |

In one embodiment, additional optional components are added to the solution formulation, including, but not limited to pore forming agents (polyethylene glycol, maleic acid), solvents (dimethyl sulfoxide (DMSO), dimethylacetamide (DMAc), and N-methyl-2-pyrrolidone (NMP)), nanomaterials (graphene oxide, carbon nanotubes, etc.), and polymers (polyether sulfone (PES), sulfonated polysulfone and sulfonated polyethersulfone and their mixtures thereof). To those experienced in the membrane field, there is an extensive range of materials that can be employed for the fabrication of NFMs that could be used in different applications such as in water treatment.

Process parameters like solution flow rate, gas pressure, voltage, and working distance affect the nanofiber generation. In studies on solution feed rate, it was observed that as the feed rate increased, the droplets decreased, but the fibers became thicker. Low feed rates, on the other hand, caused wetter surfaces to form visible droplets during production.

An important parameter is air pressure. During solution blowing processes (without applied electrical voltage), high velocity airflow attenuates the polymer jet, helping to evaporate solvent and solidify the nanofibers into ultrafine fibers. Thus, the higher air pressure increases the shear force at the gas/solution interface and causes the fiber diameter to decrease. Droplets and wet surface were obtained at low air pressure (1.5 bars). By increasing the pressure up to 3 bars, a fibrous structure became dominant, and a drier surface was obtained. It was determined that with the further increase in air pressure, the fine fibers could not withstand this pressure and broke off, becoming entangled and scattered. Pressures in the range of 1.5 and 2.0 bar were selected as an optimum range where no droplets were seen and the fibers were not scattered.

The solution concentration, which is directly related to viscosity, has a noticeable influence fiber diameter and morphology. The production of fibers from polymeric solutions is mainly due to the entanglement of polymeric chains, and this entanglement needs a specific concentration of the polymer in the solution. To optimize solution concentration, several productions were made starting from low concentration values. However, low concentration solutions had a low viscosity and droplet, and bead formation became apparent. Since fiber formation requires specific shear forces and electric forces, operations were carried out considering all the forces. High concentrations produce thicker fibers, i.e., about 1-2 μm. For this reason, a 30% concentration range was determined to optimal.

### PSF Nanofiber Membrane Post Treatment by Hot Pressing:

After the preparation of the nanofiber membrane, the hot-press post treatment was carried out. Solution blown nanofiber membrane samples prepared from polysulfone had a thickness in the range of 500-730 microns. Hot-press post treatment hardens and mechanically improves polymers by subjecting them to a temperature near or above the glass transition temperature. The hot-pressing (post treatment) was carried out at 150° C. temperature at a load 0.5 tons/m² for 10 minutes to determine the effect of hot-press post treatment on the structural and mechanical properties of the NFMs.

The procedure for the hot-press post treatment of PSF nanofiber membranes comprises:
After solution blow spinning, the nanofibrous supports along with the polyester backing layer were positioned between a set of steel plates;
The membranes were hot-pressed at 150° C. for 10 minutes at a load 0.5 tons/m²;
The steel plates were taken from the hot-press and cooled; and
After cooling, the membrane samples were taken from the steel plates.

### PSF Nanofiber Membrane Characterization:

The structural changes in the PSF nanofiber membrane samples along with the changes in mechanical and thermal properties were analyzed. Different characterization such as mechanical stability analysis (tensile testing), thermogravimetric analysis (TGA), differential scanning calorimetry (DSC), atomic force microscopy (AFM), scanning electron microscope (SEM), contact angle analysis, and dynamic mechanical analysis (DMA) of the hot-pressed PSF-based NFM samples was conducted and compared to the normal polysulfone-based NFM samples.

Veeco Metrology Nasoscope IV Scanned Probe Microscope Controller Dimension 3100 SPM was used to examine the surface topography of hot-pressed PSF-based NFM samples and normal PSF-based NFM samples. AFM scanning probes with a spring constant of 0.02-0.77 N/m were used during characterization. The surface roughness and morphology of the sample size of 20 atoms were taken by 20 atoms and the RMS surface roughness observed in this example was the average value of three different locations. The surface morphology and nanofiber diameter distribution were examined by scanning electron microscope after the samples were coated with a gold sputter to improve their electron conductivity. The SEM instrument used was Nova Nano SEM 450 with a voltage capacity ranging from 200 V to 30 kV. The fiber samples needed pretreatment, including spraying a thin layer of gold particles on the surface, to improve the contact between the beam and the sample. A Perkin Elmer instrument was used for DSC analysis. The heating range was from 30° C. to 300° C. and the rate of heating was 20° C./minute. After a holding period of three minutes, the rate of cooling provided was 20° C./minute. A Perkin Elmer (TGA 4000) was used for the TGA analysis. The heating range 30° C.-300° C. and the heating rate was 20° C./minute. After a holding period of three minutes, the rate of cooling provided was 20° C./minute. Mechanical properties of the nanofiber membranes such as tensile strength and Young's modulus were tested using Lloyd materials testing instrument from AMETEK. The nanofiber membrane samples (2 cm×5 cm dimensions) were pulled at a constant rate of 2 mm/min, thus generating a strain versus stress graph that enables the derivation of the different mechanical properties. The degree of hydrophobicity was evaluated through the contact angle measurements using the OCA35 system from DataPhysics. The Young-Laplace model was used to determine the contact angle, which is directly correlated to the surface roughness of the prepared samples. A charge-coupled device (CCD) camera to capture the droplet accumulation on the sample surface was also used. The DMA study of the NFMs were carried out using the TA instrument RSA-G2.

Table 1-2 presents the thickness variations of hot-press post treated PSF-based NFM samples after compared to the base samples. As shown in Table 1-2, the thickness of the PSF-based NFM base samples were reduced after the hot-press post treatment.

TABLE 1-2
Thickness and Contact Angle of PSF-based NFM Samples Compared to Base Samples

| | | | | PSF-based | | |
|---|---|---|---|---|---|---|
| | | Thickness of | | NFM samples | Thickness of | Contact angle |
| | | PSF-based | Contact angle | after hot-press | PSF-based NFM | analysis of |
| | PSF-based | NFM base | analysis of | treatment at | hot-pressed | PSF-based NFM |
| Sample | NFM base | samples | NFM base | 150° C. for 10 min | samples | hot-pressed |
| No. | samples | (microns) | samples | at a load 0.5 tons/m² | (microns) | samples |
| 1 | A1 | 730 | 129.7405 | A1T1 | 380 | 137.4211 |
| 2 | B1 | 770 | 128.1223 | B1T1 | 400 | 126.32 |
| 3 | E1 | 648 | 129.2397 | E1T1 | 425 | 140.1528 |
| 4 | E2 | 720 | 122.700 | E2T1 | 369 | 136.3973 |
| 5 | F1 | 705 | 137.9979 | F1T1 | 370 | 140.94 |
| 6 | F2 | 665 | 138.2465 | F2T1 | 310 | 136.4529 |
| 7 | T5 | 538 | 133.756 | T5T1 | 380 | 140.868 |

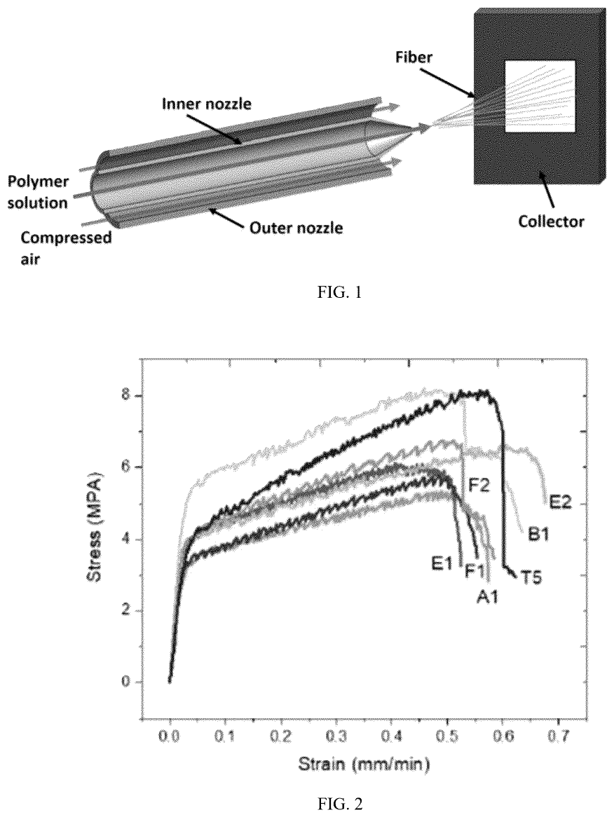

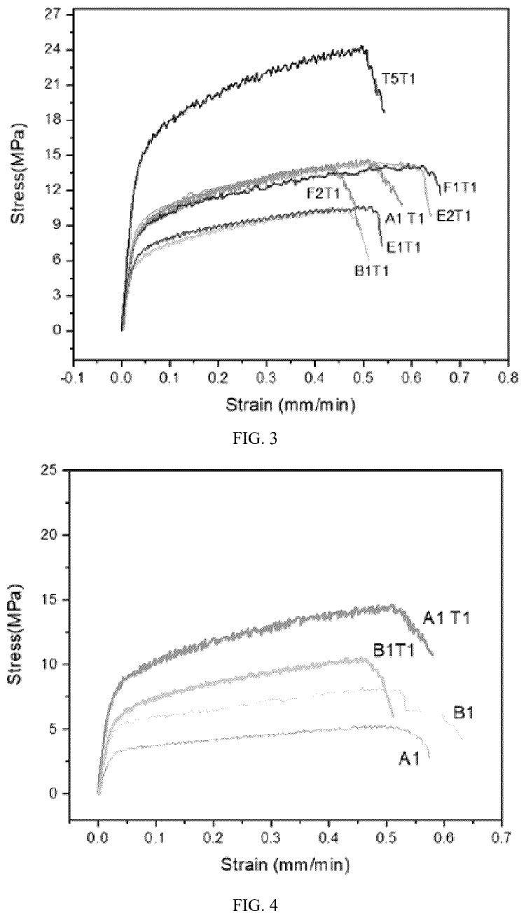

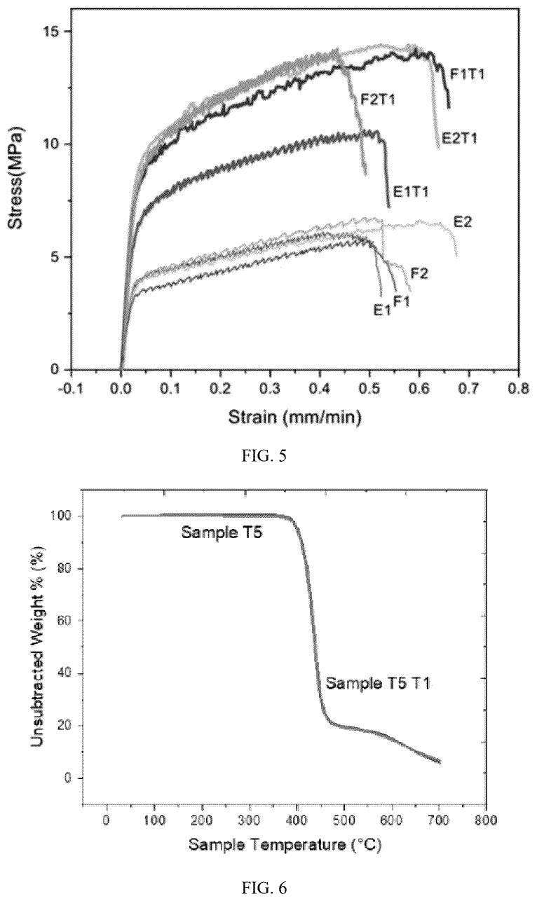

Table 1-3 presents the mechanical strength of PSF-based NFMs produced as described above in terms of Young's modulus, tensile strength and stiffness, before and after the hot-press treatment process. FIG. 2 presents the mechanical properties of PSF-based NFM base samples prepared as described herein, and FIG. 3 presents the mechanical properties of the corresponding PSF-based NFM samples after hot-pressing. FIG. 4 and FIG. 5 show the mechanical properties of PSF base and hot-pressed samples with 20 wt. % and 17 wt. % concentrations, respectively. As shown in Table 1-3, FIG. 2, FIG. 3, FIG. 4, and FIG. 5, the mechanical properties of PSF-based NFMs described herein were enhanced significantly after hot-press treatment. The tensile strength of the samples increased up to 2 times with the 150° C. hot press treatment for 10 minutes. The hot-pressed samples showed a 3-fold increase Young's modulus values with the 150° C. hot press treatment for 10 minutes under 0.5 tons/m² load. This trend confirmed that hot pressing under the specified conditions significantly increased the fiber strength. Without being bound to any theory, this improvement in the mechanical strength is due to the fusion of the PSF nanofibers on the top and bottom surfaces of the membrane. Also, without being bound to any theory, the higher value for the mechanical property could be due to the dense packing of the nanofiber layers and the inter-nanofiber interactions. The mechanical strength generally improved with a thicker layer and smaller fiber diameter. Even though all the samples showed improvement in mechanical properties, samples T5 and T5-t1 were further characterized as model samples.

TABLE 1-3
Mechanical properties of PSF-based NFMs fabricated according to the
current invention, before and after hot-press treatment process

| | Tensile | | Young's | Hot | Tensile | Young's |
|---|---|---|---|---|---|---|
| Base | Strength | Stiffness | Modulus | Pressed | Strength | Modulus |
| Samples | (Mpa) | (N/mm) | (Mpa) | Samples | (Mpa) | (Mpa) |
| A1 | 5.4412 | 63.369 | 216.13 | A1T1 | 14.738 | 627.80 |
| B1 | 7.9123 | 87.228 | 283.21 | B1T1 | 10.615 | 368.43 |
| E1 | 6.1962 | 54.294 | 209.47 | E1T1 | 10.684 | 336.16 |
| E2 | 6.3416 | 49.579 | 172.15 | E2T1 | 14.642 | 473.92 |
| F1 | 5.8022 | 56.31 | 199.68 | F1T1 | 13.267 | 454.55 |
| F2 | 4.9231 | 60.42 | 227.14 | F2T1 | 14.563 | 455.63 |
| T5 | 8.20 | 46.19 | 190.41 | T5T1 | 24.63 | 867.41 |

As shown in FIG. 6, the PSF-based NFM hot-pressed sample (T5-t1) showed the same thermal stability as compared to the PSF-based NFM base sample (T5). This confirms the hot-press post treatment at the specified conditions as described herein will not impact the thermal stability of the hot-press post-treated nanofiber membranes.

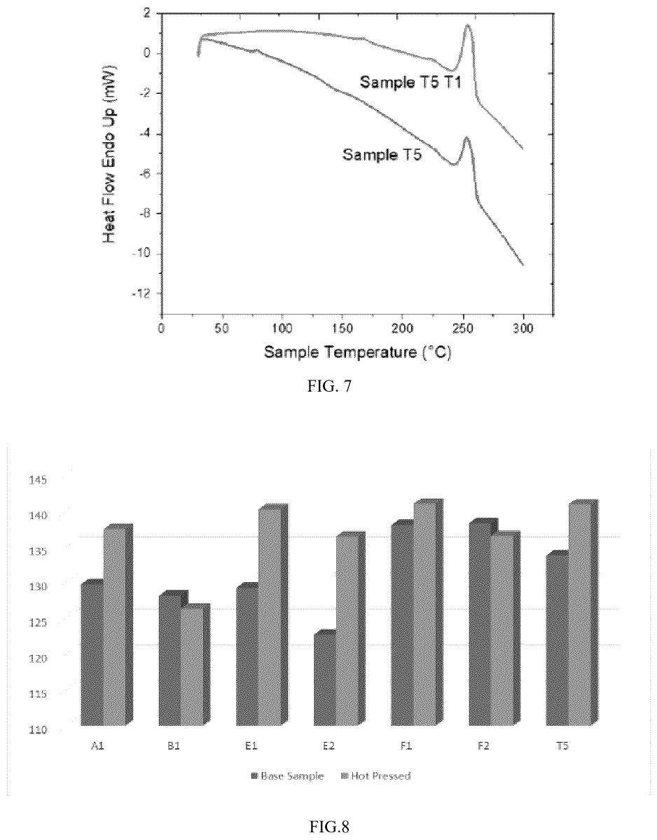

As presented in FIG. 7, the DSC analysis of PSF-based NFM base sample (T5) and the corresponding hot-pressed sample (T5-t1) confirmed that hot-press post treatment at the specified conditions as described herein had no effect on the nanofiber crystallization.

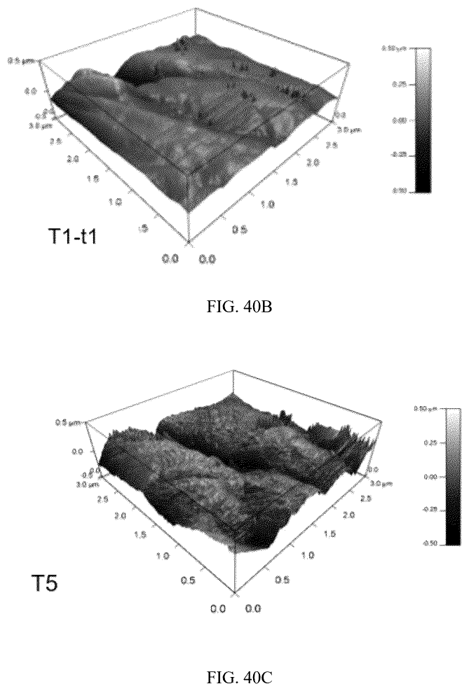

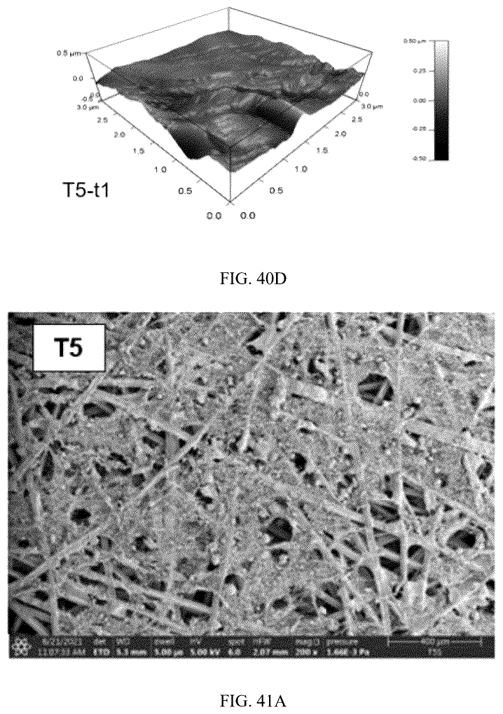

As displayed in FIG. 40C and Table 1-4, the AFM analysis of PSF-based NFM base samples and hot-pressed samples confirmed that hot-press post treatment at the specified conditions as described herein affects the surface roughness of the samples. In the base sample T5, the surface roughness was 94 nm. However, for the corresponding hot-treated sample T5-t1, the roughness value was in the range of 49.60 nm. The lower value of T5-T1 is an indication that the surface is smoother after hot-pressing compared to base sample. In general, the surface roughness value for most commercial and lab synthesized polyamide membranes is in the range of about 50 nm.

TABLE 1-4
Surface roughness values of samples PSF-based NFMs
before and after hot-press treatment process

| Samples | Material | Rms (nm) |
|---|---|---|
| T5 | Base PSF NFMs | 94.086 |
| T5-T1 | Hot-pressed PSF NFMs | 49.601 |
| | (150° C. for 10 mins) | |

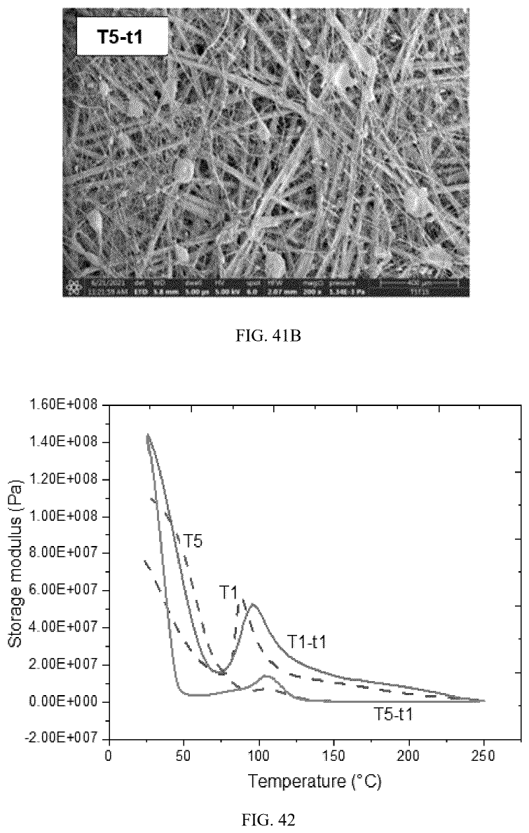

SEM images of the PSF-based NFM base sample (T5) and the hot-pressed sample (T5-t1) are illustrated in FIG. 41A-41B. The PSF-based nanofiber membrane morphology was different after the hot-press post-treatment. As shown in the SEM images, defective fibers with beads and ribbon-like morphology were observed in the T5 base sample because of the incomplete solvent evaporation from the jet surface. However, with the application of hot-press treatment temperature, the bead formation was not observed due to the rearrangement of polymer chains at high temperatures. Without being bound to any theory, during the hot-press treatment, partial fiber fusion takes place, resulting in the inter-fiber welding at fiber crossover points, which contributes to the structural integrity to the membranes. This nanofiber fusing was also clearly observed from the tensile testing results, which leads to mechanical property improvement. Moreover, the SEM images illustrated the decrease in the nanofiber pore size after the hot-press treatment. Thus, this hot-press treatment can cause reduction in pore size, which can be very beneficial for several applications of nanofiber membranes, such as water treatment.

As show in FIG. 8 and Table 1-2, the PSF-based NFM hot-pressed samples prepared as described herein demonstrated an increase in hydrophobicity as compared to the PSF-based NFM base sample. The PSF-based NFM base sample exhibited an increase in the range of 8-12°.

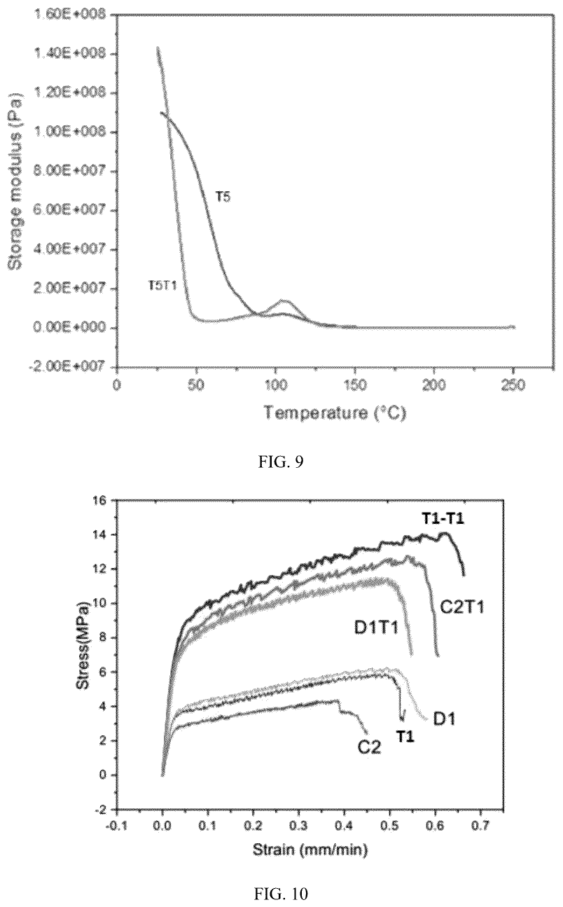

As presented in FIG. 9, the Young's modulus of the hot-pressed T5-t1 sample obtained from the tensile testing was in line with the storage modulus value noted from the DMA examination. The storage modulus of the base sample increased from 109.6 MPa to 142.6 MPa after the hot-press treatment under 0.5 tons/m² load at temperature 150° C. for 10 minutes.

### Example 2. Effect of Processing Conditions and Hot-Press Treatment on the Properties of SBS Polyethersulfone-based Nanofiber Membranes

### Materials:

Polyethersulfone (GF37900436—granule, nominal granule size 3 mm) was obtained from Sigma Aldrich. N-Methyl-2-pyrrolidone/toluene solvent mixture prepared at a concentration range of 2:1 wt. was also purchased from Sigma Aldrich.

The solution blow spinning apparatus is as described in Example 1.

### Nanofiber Preparation Using SBS Technology:

The PES-based nanofiber membrane production using SBS technology is as follows: PES powder and N-methyl-2-pyrrolidone/toluene solvent mixture (2:1 wt.) (20 wt. % and 25 wt. % of PES to the solvent mixture) was mixed well in a water bath to obtain the PES solution. The air pressure of the system was kept as 2.0 bar and the feeding rate of the polymer solution was 8 mL/h. The PES solution was pumped across a 21-gauge needle, which was positioned within a concentric nozzle (di—2 mm) and at a working distance of 50 cm. The PES solution was pumped across the interior nozzle and a pressurized velocity gas was passed across the concentric exterior nozzle (FIG. 1). The polymer concentration was 20 wt % and 25 wt % and the deposition time was 10 minutes for the nanofibers. PES solutions were solution blown spun at an 8.0 mL/h feed rate, a 2.0 bar air pressure, and a voltage of 0 or 20 kV). The PES solution was fed across a concentric nozzle. As the solution came into contact with compressed air at the nozzle tip, it was stretched out on the way to the collector with the shear effect from the air to produce a nanofiber mat. The PES-based nanofiber membrane substrates were prepared as per the polymeric concentration and process parameters presented in Table 2-1. The nonwoven polyester with increased mechanical property was selected as the structural support. The PES-based NFMs were deposited on top of the polyester support layer in the course of the SBS process.

TABLE 2-1
Details of PES-based NFM Fabrication

| | | | Solution | | | |
|---|---|---|---|---|---|---|
| | | Concen- | Feeding | Air | | Production |
| Sample | Polymer | tration | Rate | Pressure | Voltage | Time |
| No. | type | (wt. %) | (mL/h) | (bar) | (kV) | (min) |
| 1 | T1 | 25 | 8 | 2.0 | 20 | 10 |
| 2 | C2 | 25 | 8 | 2.0 | — | 10 |
| 3 | D1 | 20 | 8 | 2.0 | 20 | 10 |

Along with what is presented in Table 2-1, other components can also be added to solution formulations, including pore forming agents (maleic acid, polyethylene glycol), solvents (N-dimethyl formamide, dimethylacetamide (DMAc), dimethyl sulfoxide (DMSO)), nanomaterials (carbon nanotubes, graphene oxide, etc.), and polymers (polysulfone, sulfonated polyethersulfone, sulfonated polysulfone and their mixtures thereof). To those in the membrane field, there are a wide range of materials that can be used for the manufacture of nanofiber membranes for water treatment applications.

Process parameters such as voltage, solution flow rate, gas pressure, and working distance influence the nanofiber generation. In studies on polymer solution feed rate, it was shown that with increased feed rate, droplets were reduced, however the nanofibers were thicker. Conversely, lower feed rates resulted in wetter surfaces to form visible droplets at the time of production. For this reason, a feed rate of 8 mL/h was selected as the optimal value. To optimize the uniform distribution of the nanofibers deposited on the surface, 10 minutes was selected as the deposition time.

### PES-Based NFM Post Treatment by Heat-Press:

After the fabrication of the PES-based NFM, the heat-pressing post treatment for membrane modification was performed. The PES-based NFMs prepared by SBS technology as described herein were about 700-800 microns thick. Heat-press post-treatment hardens and increases the mechanical properties of polymers by exposing them to a temperature close to or above their glass transition temperature. As described herein, the fabricated NFMs were heat-press post-treated at varying temperatures (80° C., 150° C., 175° C. and 200° C.), different pressing times (5, 10 and 20 minutes) and under varying loads (0.5, 10 and 20.0 tons/m²) to study the impact of heat-press post treatment temperature, time and load on the mechanical properties and morphological characteristics of the NFMs.

The method for the heat-press post-treatment of PES-based NFMs comprises:
After the SBS process, the PES nanofiber supports together with the polyester backing layer were placed in the middle of a set of steel plates;
The PES nanofiber membranes were heat-pressed at varying temperatures (80° C., 150° C., 175° C. and 200° C.), different pressing times (5, 10 and 20 minutes) and under varying loads (0.5, 10 and 2.0 tons/m²);
Once the specific time was reached, the steel plates were removed from the heat-press and cooled; and,
After cooling, the membrane samples were removed from the steel plates and characterized.

### Characterization of PES-Based NFM Samples:

The structural variations in the PES-based NFMs along with the differences in the mechanical and thermal properties were evaluated. Various characterization such as mechanical strength analysis (tensile testing), contact angle analysis, scanning electron microscope (SEM), atomic force microscopy (AFM), differential scanning calorimetry (DSC), thermogravimetric analysis (TGA), and dynamic mechanical analysis (DMA) of the heat-press post-treated PES-based nanofiber membranes were carried out and compared to the normal PES-based nanofiber membranes.

A Veeco Metrology Nasoscope IV Scanned Probe Microscope Controller Dimension 3100n SPM was used to examine the surface topography of the PES-based NFM base samples and heat-pressed samples. AFM scanning probes with a spring constant in the range of 0.02-0.77 N/m were also used. The surface morphology and roughness of the specimen size of 20 atoms were taken by 20 atoms and the RMS surface roughness was the average value of three distinct positions. Nanofiber diameter distribution and surface morphology were analyzed by SEM after the specimens were coated using a fold sputter to improve electron conductivity. The SEM instrument was Nova Nano SEM 450, and the voltage capacity ranged from 200 V to 30 kV. The nanofiber specimens required pretreatment, including the spraying of a thin layer of gold particles on the surface to improve the contact between the specimen and the beam. A Perkin Elmer instrument was used for DSC analysis. The heating range was from 30° C. to 300° C. and the rate of heating was 20° C./minute. After the three-minute holding period, the cooling rate provided was 20° C./minute. A Perkin Elmer (TGA 4000) was used for the TGA analysis. The heating range 30° C.-300° C. and the heating rate was 20° C./minute. The different mechanical properties of the NFMs such as Young's modulus and tensile strength were determined using AMETEK's Lloyd materials testing instrument. The NFM samples (2 cm×5 cm dimensions) were pulled at a 2 mm/min constant rate, consequently generating a strain versus stress graph and thus deriving the values of Young's modulus and tensile strength. The hydrophobicity degree was assessed through the contact angle measurements using the sessile drop method. The contact angle analysis was carried out using the OCA35 instrument from DataPhysics. To determine the contact angle, the Young-Laplace model was used, and the values were directly related to the surface roughness of the NFM samples. A charge-coupled device (CCD) camera was used to capture droplet accumulation on the sample surface. The DMA study of the nanofiber membranes was performed using the TA instrument RSA-G2.

The tensile strength and the Young's modulus of the base T1 sample when tested for tensile were 5.47 MPa and 191.88, respectively.

Tables 2-2 through 2-13 present the heat-press post treatment conditions and the resultant mechanical properties as described herein.

TABLE 2-2
PES-based NFM sample T1 heat-pressed at constant load
0.5 tonne/m² varying the temperature and time

| | Constant | | | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 0.5 | 150 | 10 | 21.056 | 536.25 |
| 2 | 0.5 | 175 | 10 | 22.07 | 574.95 |
| 3 | 0.5 | 150 | 5 | 26.378 | 587.32 |
| 4 | 0.5 | 150 | 20 | 19.027 | 590.95 |
| 5 | 0.5 | 200 | 10 | 19.858 | 543.78 |
| 6 | 0.5 | 80 | 10 | 31.734 | 682.68 |

TABLE 2-3
PES-based NFM sample T1 heat-pressed at constant load
1.0 tonne/m² varying the temperature and time

| | Constant | | | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 1.0 | 150 | 10 | 18.962 | 535.37 |
| 2 | 1.0 | 200 | 10 | 17.885 | 685.68 |
| 3 | 1.0 | 80 | 10 | 39.193 | 997.91 |
| 4 | 1.0 | 150 | 20 | 28.374 | 670.65 |

TABLE 2-4
PES-based NFM sample T1 heat-pressed at constant load
2.0 tonne/m² varying the temperature and time

| | Constant | | | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 2.0 | 200 | 10 | 23.025 | 597.12 |
| 2 | 2.0 | 80 | 10 | 44.182 | 1461.9 |
| 3 | 2.0 | 150 | 20 | 30.216 | 842.87 |
| 4 | 2.0 | 150 | 10 | 29.626 | 722.24 |

TABLE 2-5
PES-based NFM sample T1 heat-pressed at constant
temperature 150° C. varying the load and time

| | | Constant | | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 0.5 | 150 | 10 | 21.056 | 536.25 |
| 2 | 0.5 | 150 | 5 | 26.378 | 587.32 |
| 3 | 0.5 | 150 | 20 | 19.027 | 590.95 |
| 4 | 1.0 | 150 | 10 | 18.962 | 535.37 |
| 5 | 1.0 | 150 | 20 | 28.374 | 670.65 |
| 6 | 2.0 | 150 | 20 | 30.216 | 842.87 |
| 7 | 2.0 | 150 | 10 | 29.626 | 722.24 |

TABLE 2-6
PES-based NFM sample T1 heat-pressed at constant
temperature 200° C. and constant time 10 mins at varying load

| | | Constant | | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 1.0 | 200 | 10 | 17.885 | 685.68 |
| 2 | 2.0 | 200 | 10 | 23.025 | 597.12 |
| 3 | 0.5 | 200 | 10 | 19.858 | 543.78 |

TABLE 2-7
PES-based NFM sample T1 heat-pressed at constant
temperature 80° C. and constant time 10 mins at varying load

| | | Constant | | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 0.5 | 80 | 10 | 31.734 | 682.68 |
| 2 | 1.0 | 80 | 10 | 39.193 | 997.91 |
| 3 | 2.0 | 80 | 10 | 44.182 | 1461.9 |

TABLE 2-8
PES-based NFM sample T1 heat-pressed at constant load 0.5
tonne/m2 and constant time 10 mins at varying temperature

| | | | Constant | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 0.5 | 150 | 10 | 21.056 | 536.25 |
| 2 | 0.5 | 175 | 10 | 22.07 | 574.95 |
| 3 | 0.5 | 200 | 10 | 19.858 | 543.78 |
| 4 | 0.5 | 80 | 10 | 31.734 | 682.68 |

TABLE 2-9
PES-based NFM sample T1 heat-pressed at constant
temperature 150° C. and constant load 0.5 tonne/m² at varying time

| | | Constant | | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 0.5 | 150 | 10 | 21.056 | 536.25 |
| 2 | 0.5 | 150 | 5 | 26.378 | 587.32 |
| 3 | 0.5 | 150 | 20 | 19.027 | 590.95 |

TABLE 2-10
PES-based NFM sample T1 heat-pressed at constant
temperature 150° C. and constant time 10 mins at varying load

| | | Constant | Constant | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 0.5 | 150 | 10 | 21.056 | 536.25 |
| 2 | 1.0 | 150 | 10 | 18.962 | 535.37 |
| 3 | 2.0 | 150 | 10 | 29.626 | 722.24 |

TABLE 2-11
PES-based NFM sample T1 heat-pressed at constant
temperature 150° C. and constant time 20 mins at varying load

| | | Constant | | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 0.5 | 150 | 20 | 19.027 | 590.95 |
| 2 | 1.0 | 150 | 20 | 28.374 | 670.65 |
| 3 | 2.0 | 150 | 20 | 30.216 | 842.87 |

TABLE 2-12
PES-based NFM sample T1 (with voltage) heat-pressed at constant
load 0.5 tonne/m², constant time 10 mins at varying temperatures

| | Constant | | Constant | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 0.5 | 0 | 10 | 5.4724 | 191.88 |
| 2 | 0.5 | 150 | 10 | 13.287 | 403.39 |
| 3 | 0.5 | 80 | 10 | 31.734 | 682.68 |
| 4 | 0.5 | 200 | 10 | 19.858 | 543.78 |

TABLE 2-13
PES-based NFM sample T1 (without voltage) heat-pressed at constant
load 0.5 tonne/m2, constant time 10 mins at varying temperatures

| | Constant | | Constant | Tensile | Young's |
|---|---|---|---|---|---|
| Sample | Load | Temperature | Time | Strength | Modulus |
| No. | (tonne/m²) | (° C.) | (mins) | (MPa) | (MPa) |
| 1 | 0.5 | 0 | 10 | 4.4339 | 197.5 |
| 2 | 0.5 | 150 | 10 | 13.329 | 412.97 |
| 3 | 0.5 | 80 | 10 | 19.101 | 611.96 |
| 4 | 0.5 | 200 | 10 | 31.658 | 787.97 |

TABLE 2-14
Naming, thickness and contact angles of the PES base samples and heat-pressed samples

| | | | | PES-based | Thickness of | |
|---|---|---|---|---|---|---|
| | | | | nanofiber membrane | PES-based | |
| | | Thickness of | Contact angle | samples after | nanofiber | |
| | | PES-based | analysis of | heat-press | membrane | Contact angle |
| | PES-based | nanofiber | PES-based | post-treatment | heat-press | analysis of |
| | nanofiber | membrane | nanofiber | at 150° C. at a | post-treated | PSF-based NFM |
| Sample | membrane | base samples | membrane | load 0.5 tonnes/ | samples | heat-pressed |
| No. | base samples | (microns) | base samples | m² for 10 min | (microns) | samples |
| 1 | T1 | 730 | 129.38 | C1T1 | 388 | 133.96 |
| 2 | C2 | 770 | 137.77 | C2T1 | 430 | 124.09 |
| 3 | D1 | 648 | 111.41 | D1T1 | 420 | 132.68 |

As presented in Table 2-14, the thickness of PES-based nanofiber membrane base samples decreased after the heat-press post treatment.

Tables 2-2 through 2-13 present the mechanical properties of PES-based nanofiber membranes with respect to tensile strength and Young's modulus before and after the heat-press post-treatment process.

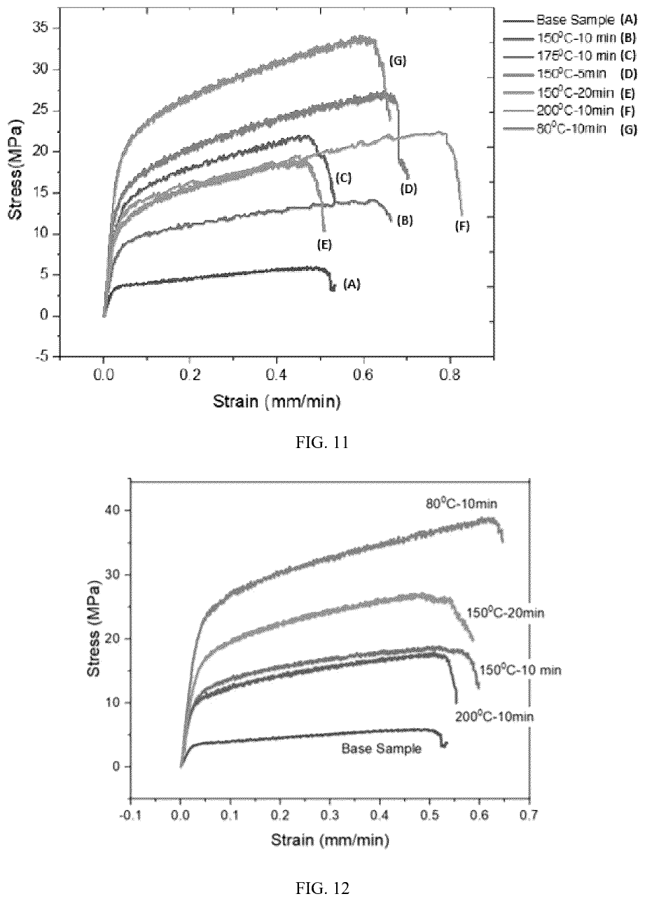

As shown in FIG. 11 and Table 2-2, PES-based NFM sample T1, which was heat-pressed at a constant load of 0.5 tonne/m² with varying temperatures and times, demonstrated superior mechanical properties when heat-treated at 80° C. for 10 minutes. The tensile strength and Young's modulus values of T1 when heat treated at the above mentioned conditions were 31.734 MPa (a 2-fold increase compared to the base sample) and 682.68 MPa (a 3-fold increase compared to the base sample), respectively.

As shown in FIG. 12 and Table 2-3, the PES-based NFM sample T1 heat-pressed at a constant load of 1.0 tonne/m² with varying temperatures and times exhibited superior mechanical properties when heat-treated at 80° C. for 10 minutes. The tensile strength and Young's modulus values of T1 at the above mentioned conditions were 39.193 MPa (a 7-fold increase compared to the base sample) and 997.91 MPa (a 5-fold increase compared to the base sample), respectively.

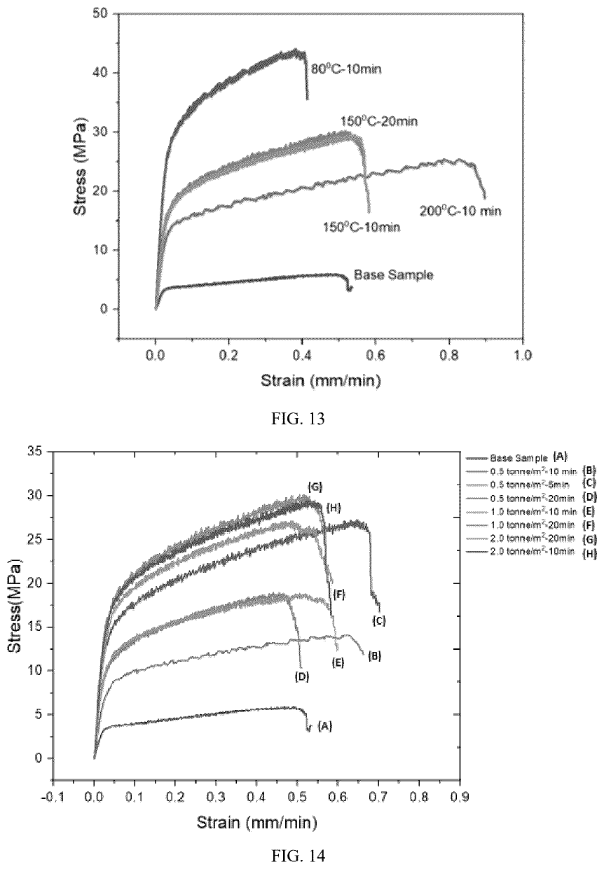

As shown in FIG. 13 and Table 2-4, the PES-based NFM sample T1 heat-pressed at a constant load of 2.0 tonne/m² with varying temperatures and times showed superior mechanical properties when heat-treated at 80° C. for 10 minutes. The tensile strength and Young's modulus values of T1 when heat treated at the above mentioned conditions were 44.182 MPa (a 8-fold increase compared to the base sample) and 1461.9 MPa (a 7-fold increase compared to the base sample), respectively.

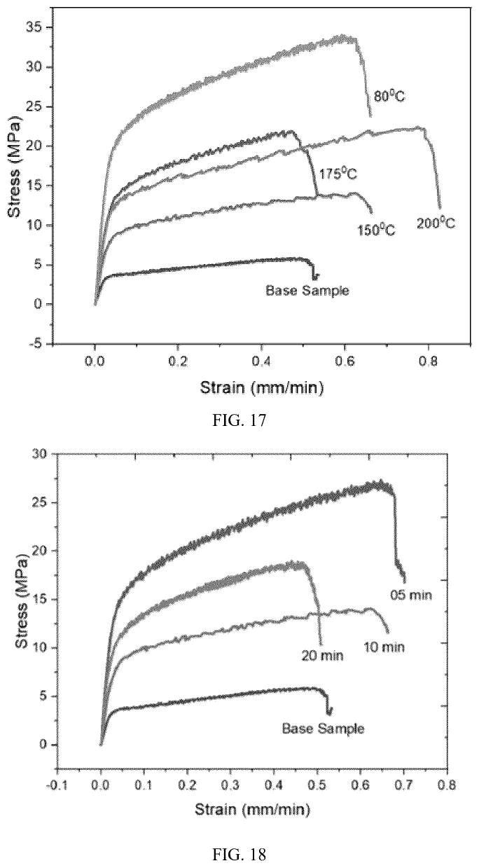

When the PES-based NFM sample T1 was heat-pressed at different specific loads (0.5 tonne/m², 1.0 tonne/m², 2.0 tonne/m²) varying the temperature (80° C., 150° C., 200° C.) and time (10 minutes, 20 minutes), improved mechanical properties were observed at 80° C. and 10 minutes. As shown in FIGS. 11, 12 and 13, the greatest improvement in the mechanical properties observed for T1 when it was heat treated at 80° C. for 10 minutes under a load of 2.0 tonne/m². FIG. 17 and Table 2-7 show the effect on mechanical properties of the load (0.5-2.0 tonne/m²) is varied, but the time and temperature are constant (10 minutes and 80° C.).

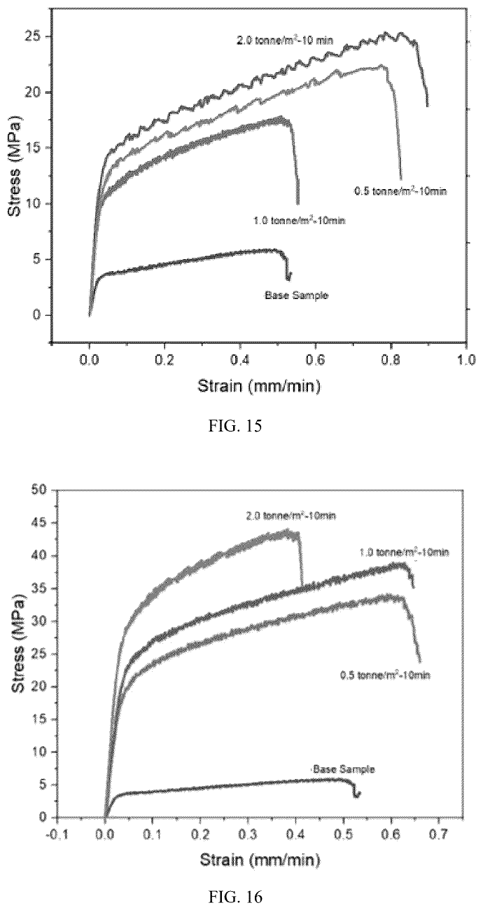

As shown in FIG. 15 and Table 2-6, the PES-based NFM sample T1 heat-pressed at a constant temperature of 200° C. for 10 minutes with various loads exhibited superior mechanical properties when heat-treated under 2.0 tonne/m². The tensile strength and Young's modulus values of T1 when heat treated at 200° C. for 10 minutes under a load of 2.0 tonne/m² were 23.025 MPa (a 4-fold increase compared to the base sample) and 597.12 MPa (a 3-fold increase compared to the base sample), respectively.

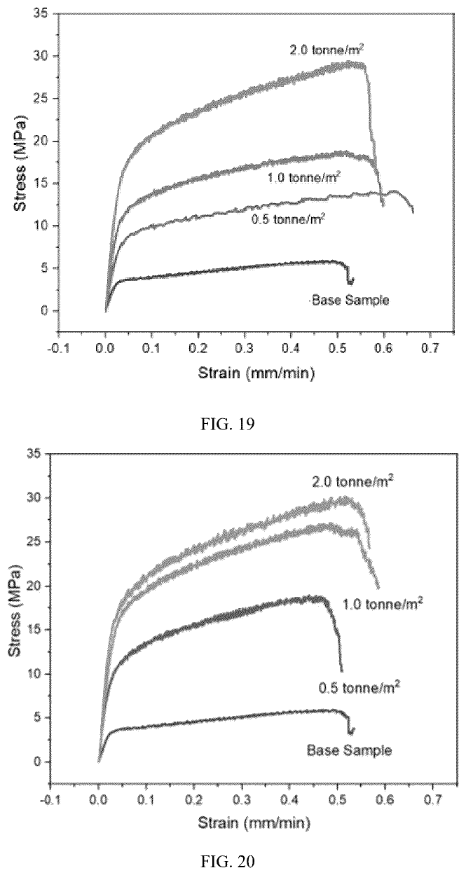

As shown in FIG. 19 and Table 2-10, the PES-based NFM sample T1 heat-pressed at a constant temperature of 150° C. for 10 minutes at various loads showed superior mechanical properties when heat-treated 2.0 tonne/m². The tensile strength and Young's modulus values of T1 when heat treated at 150° C. for 10 minutes under a load 2.0 tonne/m² were 29.626 MPa (a 5-fold increase compared to the base sample) and 722.4 MPa (a 3-fold increase compared to the base sample) respectively.

Thus, when the PES-based NFM sample T1 was heat-pressed at different specific temperatures of 200° C., 80° C., and 150° C. for 10 minutes at varying loads, improved mechanical properties were observed at 80° C. under the load of 2.0 tonne/m².

As shown in FIG. 14 and Table 2-5, the PES-based NFM sample T1 heat-pressed at a constant temperature of 150° C. with various loads (0.5-2.0 tonne/m²) and times (5-20 mins), demonstrated superior mechanical properties when heat-treated under 2.0 tonne/m² for 20 minutes. The tensile strength and Young's modulus values of T1 when heat treated at a constant temperature of 150° C. under 2.0 tonne/m² for 20 minutes were 30.216 MPa (a 5-fold increase compared to the base sample) and 842.87 MPa (a 4-fold increase compared to the base sample), respectively. FIG. 20 and Table 2-11 show the effect on mechanical properties when the load is varied (0.5-2.0 tonne/m²), but the time and temperature are constant (20 minutes and 150° C.).

As shown in FIG. 17 and Table 2-8, the PES-based NFM sample T1 heat-pressed at a constant load of 0.5 tonne/m² for 10 minutes at varying temperatures demonstrated superior mechanical properties when heat-treated at a temperature of 80° C. The tensile strength and Young's modulus values of T1 when heat treated at a constant load of 0.5 tonne/m² for 10 minutes at 80° C. were 31.734 MPa (a 5-fold increase compared to the base sample) and 682.68 MPa (a 3-fold increase compared to the base sample), respectively.

As shown in FIG. 18 and Table 2-9, the PES-based NFM sample T1 heat-pressed at a constant temperature of 150° C. and a constant load of 0.5 tonne/m² for various times demonstrated superior mechanical property when heat-treated for 5 minutes. The tensile strength and Young's modulus values of T1 when heat treated at a constant temperature of 150° C. and a constant load of 0.5 tonne/m² for 5 minutes were 26.378 MPa (a 5-fold increase compared to the base sample and 587.32 MPa (a 3-fold increase compared to the base sample), respectively.

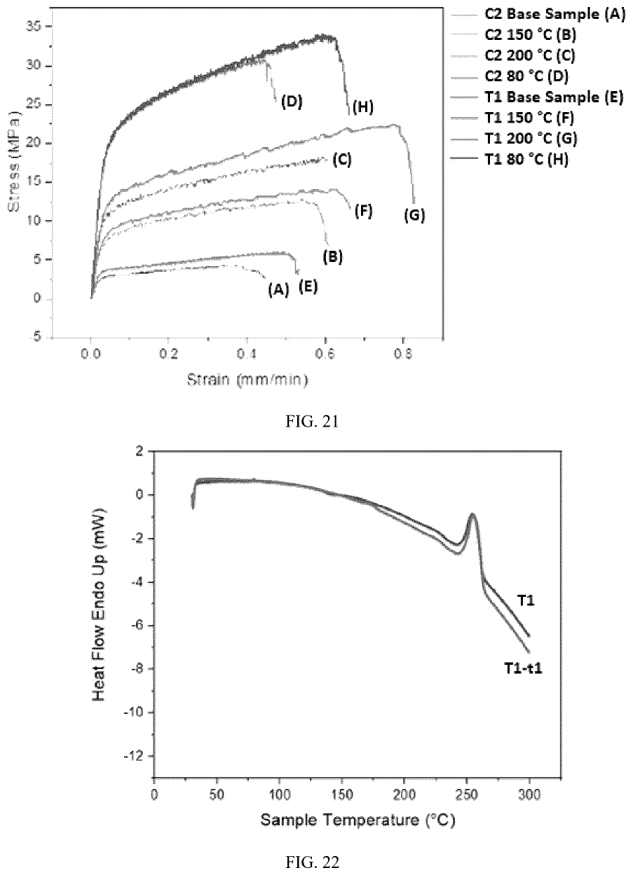

As shown in FIG. 21, Table 2-12, and Table 2-13, the PES-based NFM sample T1 (20 kV voltage applied) and C2 (no voltage applied) heat-pressed at a constant load of 0.5 tonne/m² for 10 minutes at varying temperatures demonstrated superior mechanical properties when heat-treated at 80° C. Thus, NFMs prepared using the SBS process with voltage showed better performance compared to NFMs prepared using the SBS process without any voltage.

Overall, the mechanical properties of the PES-based nanofiber membranes described herein were improved substantially after the heat-press post-treatment. The tensile strength of the samples increased up to 8-fold with 150° C. heat-press treatment for 10 minutes. The sample T1 showed an increase in Young's modulus of 7-fold with 150° C. heat-press treatment for 10 minutes. Heat-pressing under the specified conditions described herein remarkably increased the fiber strength. Without being bound to any theory, this increase in the mechanical properties is due to the fusion of the PES nanofibers on the upper and bottom surfaces of the membrane. Additionally, the higher values for the mechanical properties of the heat-pressed membranes can also be described by the inter-nanofiber interactions and the dense packing of the nanofibrous layers. Overall, the highest value was observed for the nanofiber membrane sample heat-pressed for 10 minutes at 80° C. temperature under 2.0 tonne/m². Although all hot-pressed nanofiber membrane samples showed an increase in their mechanical properties, the remaining characterization was carried out with the T1 (base sample) and T1-t1 (heat-pressed).

Sample T1 was heat-press post-treated at 150° C. for 10 minutes under a low loading of 0.5 tons/m² to afford the corresponding T1-t1. The TGA results (FIG. 22) show that the heat-pressing post-treatment at the specific conditions described herein have no effect on the thermal properties of the heat-treated PES-based NFMs.

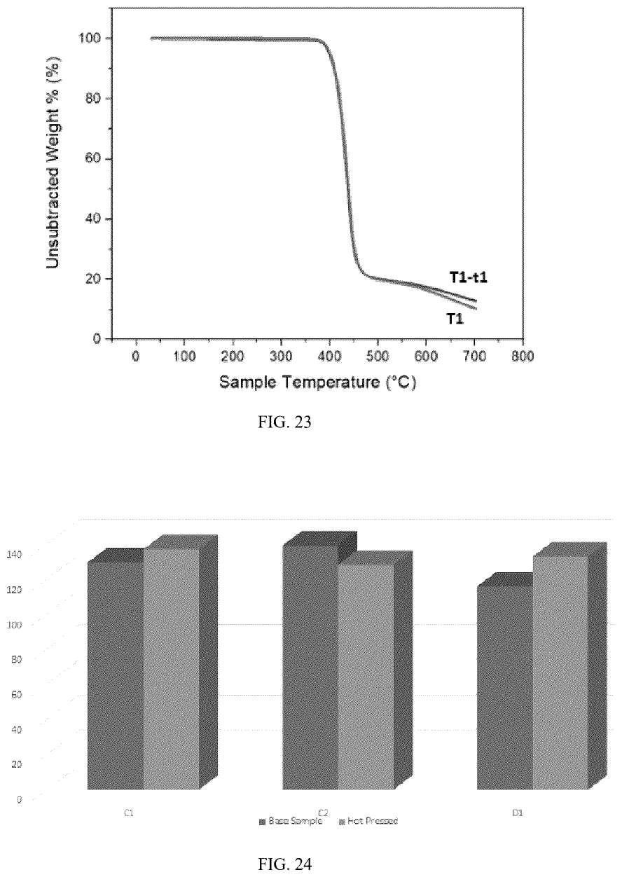

The DSC study of PES-based nanofiber membrane base sample (T1) and the resultant heat-press post-treated membrane sample (C1T1) showed that heat-press treatment of the NFMs at 150° C. for 10 minutes under a low loading of 0.5 tons/m² has no impact on the PES nanofiber crystallization (FIG. 23).

The AFM study (FIGS. 40A-40B and Table 2-15) of PES-based nanofiber membrane base sample T1 and heat-press post-treated sample T1-t1 confirmed that heat-press post treatment at 150° C. for 10 minutes under a low loading of 0.5 tons/m², can in certain embodiments, change the surface roughness of the nanofiber membrane samples. The surface roughness of the base sample T1 was 242.986 nm, and the surface roughness of resultant heat-press post-treated sample T1-t1 was 56.051. This confirms that the membrane surface became very smooth following heat-press post-treatment. Generally, the surface roughness value for the majority of the lab synthesized polyamide membranes and commercial membranes is in the range of about 50 nm.

TABLE 2-15
Surface roughness values of PES-based nanofiber membranes
before and after heat-press post-treatment

| Samples | Material | Rms (nm) |
|---|---|---|
| T1 | Base PES NFMs | 242.986 |
| T1-t1 | Heat-press post treated PES | 56.051 |
| | nanofiber membranes (150° C. | |
| | for 10 minutes under a low | |
| | loading of 0.5 tons/m2) | |

As shown in FIG. 24, the PES-based nanofiber membrane heat-press post-treated specimens prepared with the application of voltage (T1 and D1) showed an improvement in hydrophobicity relative to the PES-based nanofiber membrane base sample. When the PES-based NFM T1 was heat-press post-treated at 150° C. for 10 minutes under a low loading of 0.5 tons/m², the contact angle value increased from 129.38° (base T1) to a maximal value of 133.96°. However, the PES-based nanofiber membrane heat-press post-treated specimen, prepared without the application of voltage (C2) showed a decrease in hydrophobicity relative to the PES-based nanofiber membrane base specimen.

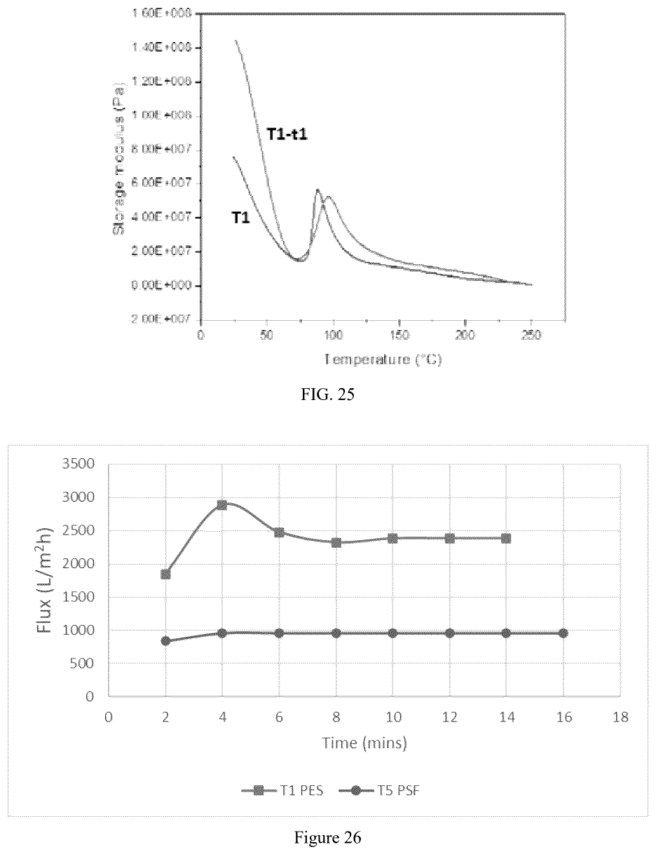

As shown in FIG. 25, the Young's modulus of heat-press post-treated PES-based nanofiber membrane specimen (T1-t1) attained from the tensile testing is in line with the storage modulus value noted from the DMA examination. The storage modulus of PES nanofiber membrane base sample increased from 75.86 MPa to 144.4 MPa subsequent to the heat-press post-treatment at a temperature 150° C. under 0.5 tons/m² load for 10 minutes.

### Example 3. Water Flux Through SBS Nanofiber-Based Thin Film Composite Forward Osmosis Membranes

### Materials:

Polyether sulfone (GF37900436—granule, nominal granule size 3 mm) and polysulfone (average Mw~35,000 by LS, average Mn~16,000) were purchased from Sigma Aldrich. N-dimethyl formamide (DMF) and N-methyl-2-pyrrolidone/toluene (solvent mixture prepared at a concentration range of 2:1 wt.) were also purchased from Sigma Aldrich. m-Phenylenediamine and trimesoyl chloride used for the interfacial polymerization process were also purchased from Sigma Aldrich. The graphene oxide used for the incorporation in the polyamide selective layer was obtained from Graphenea. The sodium chloride (NaCl) used was commercially purchased from Research Lab India and was used to prepare different concentrations of water.

### SBS Apparatus:

The SBS equipment is as described in Example 1.

### Preparation of PES and PSF Nanofibers Using SBS Technology:

Initial studies were previously carried out for optimizing the polymer solution (polysulfone or polyethersulfone) concentration, polymer feed rate, and duration of deposition time. The PES-based nanofiber membrane preparation using the SBS process was performed as follows. First, a NMP/toluene solvent mixture was prepared at a concentration range of 2:1 wt., and PES powder (25 wt. %) was dissolved in the solvent by stirring properly to afford a PES solution. The PES solution feeding rate of the system was maintained at 8 mL/h and the system air pressure was kept at 2.0 bar. The PES solution was pumped using a 21-gauge needle and placed within a concentric nozzle (di=2 mm) at 30-70 cm working distance. The PES solution was pumped through the internal nozzle and the high-velocity pressurized gas passed through the concentric exterior nozzle (FIG. 1). When the PSF solution encountered the compressed air at the nozzle tip, it was stretched out due to the shear effect developed by the air on the way to the vacuum collector, generating a nanofibrous layer on top of the polyester support placed on the collector (production time 10 minutes).

The fabrication of PSF nanofiber membranes produced by the SBS process was carried out as follows. PSF and DMF (10 wt. % of PSF by weight of the solvent) were stirred to afford the PSF solution. The PSF solution feeding rate of the system was kept at 5 mL/h and the SBS system air pressure was maintained at 1.5 bar. The PSF solution was pumped by means of a 21-gauge needle positioned within a concentric nozzle (di=2 mm) at a 30-70 cm working distance. The PSF solution was pumped through the internal nozzle and the high-velocity pressurized gas passed through the concentric exterior nozzle. When the PSF solution encountered the compressed air at the nozzle tip, it was stretched out due to the shear effect developed by the air on the way to the vacuum collector, generating a nanofibrous layer on top of the polyester support placed on the collector (production time 30 minutes).

A summary of the polymer concentrations and processing conditions for the PES-based and PSF-based NFM substrates are in Table 3-1. A polyester nonwoven with excellent mechanical property was chosen as the structural support and the PES and PSF nanofiber membranes were deposited on top of this polyester layer during the SBS process.

TABLE 3-1
Details of PES and PSF-based NFM preparation

| | | | Solution | | | |
|---|---|---|---|---|---|---|
| | | Concen- | feeding | Air | | Production |
| Polymer | | tration | rate | Pressure | Voltage | time |
| type | Naming | (wt. %) | (mL/h) | (bar) | (kV) | (min) |
| PES | T1 | 25 | 8 | 2 | 20 | 10 |
| PSF | T5 | 10 | 5 | 1.5 | 20 | 30 |

In one embodiment, extra optional components are used in the solution formulations, including are pore formers (maleic acid, polyethylene glycol), different solvents (dimethylacetamide (DMAc), dimethyl sulfoxide (DMSO), etc.), nanomaterials (carbon nanotubes, graphene oxide, etc.), and other polymers (sulfonated polyethersulfone and sulfonated polysulfone and their combinations thereof). To those experienced in the membrane field, there is a wide range of materials that can be used for the preparation of nanofiber membranes made for membrane-based water treatment and desalination.

### Hot Pressing Post Treatment on PES and PSF Based Nanofiber Membranes:

Subsequent to the preparation of PES and PSF-based nanofiber membranes, the hot-press post treatment was performed. Hot-press post treatment was carried out on the PES or PSF-based nanofiber membranes by subjecting them to a temperature above or near their glass transition temperature. The glass transition temperatures of PES and PSF are 225° C. and 188° C., respectively. The nonwoven polyester with superior mechanical property was selected as the structural support, and the PES/PSF nanofiber membranes were deposited on the topmost surface of this polyester layer at the time of SBS process. The hot-pressing (post treatment) temperatures were varied to study the effect of temperature on the structural and mechanical properties of the NFMs (Table 3-2).

TABLE 3-2
Details of Hot-pressing Conditions of PSF and PES Samples

| | Pressing Temperature | Pressing Time | Load |
|---|---|---|---|
| Condition - (t1) | 150° C. | 10 min | 0.5 tons/m² |
| Condition - (t2) | 175° C. | 6 min | 0.5 tons/m² |

The method for the hot-press post treatment of PES or PSF-based NFMs comprises:
Subsequent to the SBS process, the PES (T1) or PSF (T5) nanofiber supports, along with the polyester backing layer were positioned between two steel plates;
The NFMs were hot-pressed at 150° C. (for 10 minutes) or 175° C. (6 minutes);
The steel plates were removed from the hot-press and cooled; and
the membrane samples were removed from the steel plates.

T1 PES sample was hot-press post-treated at 150° C. (for 10 minutes) or 175° C. (6 minutes) under a low loading of 0.5 tons/m² to obtain the corresponding T1-t1 and T1-t2, respectively. T5 PSF sample was also hot-press post-treated 150° C. (for 10 minutes) or 175° C. (6 minutes) under a low loading of 0.5 tons/m² to obtain the corresponding T5-t1 and T5-t2, respectively.

Table 3-3 shows the thickness of the samples after the hot-press post treatment. As shown in Table 3-3, the thickness of the PSF and PES-based original nanofiber membrane samples decreased after the hot-press post treatment.

TABLE 3-3

| Sample | | Thickness of NFM samples |
|---|---|---|
| No. | Sample Name | (microns) |
| 1 | T1 | 780 |
| 2 | T1-51 | 315 |
| 3 | T1-t2 | 263 |
| 4 | T5 | 920 |
| 5 | T5-t1 | 580 |
| 6 | T5-t2 | 333 |

The PA selective layer was formed on top of the nanofiber membranes to develop the TFC membrane. The preparation comprises:
The nanofiber support membrane (PSF or PES+nonwoven fabric) was taped to a glass plate and immersed in an aqueous solution containing 2 wt % m-phenylenediamine for approximately 2 minutes;
The excess m-phenylenediamine solution was separated from the membrane surface and then the membrane was immersed in a solution of 0.1 wt % of trimesoyl chloride in n-hexane solvent for 1 minute;
The membrane was kept at room temperature after the trimesoyl chloride solution was drained by holding the membrane vertically. In-situ polymerization took place during this time;
The resulting membrane was rinsed with 0.2 wt % sodium carbonate aqueous solution prior and stored in deionized water;
The membrane was heated in an air-circulated oven at 105° C. for 90 seconds to allow in-situ polymerization thermal treatment; and
The resulting membrane was rinsed again with a 0.2 wt % sodium carbonate aqueous solution to form the TFC membrane.

### Thin-Film Nanocomposite (TFNC) Membrane Preparation:

A Graphene oxide (GO)-incorporated PA layer was deposited on top of the hot-pressed membranes to develop a thin-film nanocomposite membrane. The preparation method comprises:
The nanofiber support membrane (PSF or PES+nonwoven fabric) taped to a glass plate was immersed in an aqueous solution containing 2 wt % m-phenylenediamine (MPD) and 0.006 wt % graphene oxide (GO) for approximately 2 minutes. The amine groups of meta-phenylenediamine react with graphene oxide to develop new amide bonds and hydrogen bonds at the time of the ultra-sonication of the aqueous solution;
The excess MPD/GO solution was separated from the membrane surface and the membrane was immersed in a solution of 0.1 wt % of trimesoyl chloride in n-hexane solvent for 1 minute;
The membrane was kept at room temperature after the trimesoyl chloride solution was drained by holding the membrane vertically. In-situ polymerization took place during this time;
The resulting membrane was rinsed with 0.2 wt % sodium carbonate aqueous solution prior and stored in deionized water;
The membrane was heated in an air-circulated oven at 105° C. for 90 seconds to allow in-situ polymerization for thermal treatment; and
The resulting membrane was rinsed again with a 0.2 wt % sodium carbonate aqueous solution to form the thin-film nanocomposite (TFNC) membrane.

### PSF and PES-Based Nanofiber Membrane Characterization:

The structural variations in the PSF and PES nanofiber membrane specimens along with the variations in thermal and mechanical properties were examined. Various characterization like atomic force microscopy (AFM), scanning electron microscope (SEM), mechanical stability analysis (tensile testing), differential scanning calorimetry (DSC), dynamic mechanical analysis (DMA) and thermogravimetric analysis (TGA) of hot-pressed PSF and PES-based NFM samples and normal PSF and PES-based NFM samples were performed.

Mechanical stability is an important characteristic for membranes used in any separation. The tensile test method provides information about the mechanical properties of the nanofiber such as tensile strength, elastic modulus, and strain at break. During nanofiber processing, the loaded forces on the fibers can cause temporary or permanent deformation or even mechanical failure. Mechanical properties of individual nanofibers dominate the dynamic and static response, contact and friction, and final deformation in the nanofiber network. Therefore, it is essential to know if individual nanofibers are strong enough to withstand the external and internal forces exerted for performing further processing during application. Mechanical properties of the NFMs like Young's modulus and tensile strength were examined using Lloyd materials testing instrument from AMETEK. The dynamic mechanical analysis of the nanofiber membranes was performed employing the TA instrument RSA-G2. Membrane specimens were deformed at 0.008% strain amplitude with a 0.01-100 Hz frequency range in a tensile mode. Veeco Metrology Nasoscope IV Scanned Probe Microscope Controller Dimension 3100 SPM was employed for examining the surface topography of normal PES and PSF-based nanofiber membrane samples and hot-pressed PES and PSF-based nanofiber membrane samples. Atomic force microscopy scanning probes with a spring constant of 0.020.77 N/m were also employed for examining the surface morphology and roughness of the samples. Moreover, the nanofiber diameter distribution and the surface morphology were examined by SEM, after the specimens were coated with a gold sputter for improving the electron conductivity. The scanning electron microscopy instrument employed was Nova Nano SEM 450 having 200 V to 30 kV voltage capacity. For differential scanning calorimetry analysis, the instrument from Perkin Elmer with a heating range of 30° C. to 300° C. and a heating rate of 20° C./minute was used. Investigation on the thermal stability of nanofiber membranes is required in order to have safety and stability information for handling, storage, and usage of nanofiber based combined structures. For thermogravimetric analysis, a Perkin Elmer (TGA 4000) with a heating range of 30° C. to 300° C. and heating rate of 20° C./minute was used. The hydrophilicity degree was studied using the contact angle analysis, as per the sessile drop method. These measurements were carried out employing the OCA35 system from DataPhysics. The improved hydrophilicity of GO-incorporated PA deposited nanofiber membrane was confirmed by the water contact angle results. The presence of GO is clearly confirmed by the peaks observed in FTIR analysis. The FTIR instrument used in this invention was the 760 Nicolet FTIR model.

### Forward Osmosis (FO) Performance Analysis:

The main component of the FO process was the Sterlitech Cross flow CF042F cell unit, which was purchased from Sterlitech corporation. Two flow meters were mounted on the line before entry into the cell to monitor the flow on the feed and draw side. These flow meters were purchased from BROOKS, USA with max flow reading capacity of 3000 ccm/min. Two pressure gauges followed by uni-directional control valve from Festo, Germany were also installed on both the line between the cell and return line to main tanks of FS and DS respectively. In FO system, the main performance was monitored by checking the rate of change of mass with respect to time and change in conductivity. Conductivity and salinity of the system were monitored with a portable multi parameter Mode HQd40, HACH. All FO experiments were run in FO mode as well as PRO mode, where the active layer (AL) is oriented toward the FS and the porous layer (PL) faces DS for FO mode and vice versa for the PRO mode, respectively. Mostly, 0.1 M NaCl in 2 Liter was used as feed solution and 1-1.5 M NaCl was used as draw solution in all the experiments. Operation conditions of FO runs were conducted under a range of recirculation flow rate in between 800 ccm to 1200 ccm for the feed side and 500 ccm to 800 ccm for the draw side. Change in the flow rate was achieved by adjusting the pump speed of the hydraulic pump.

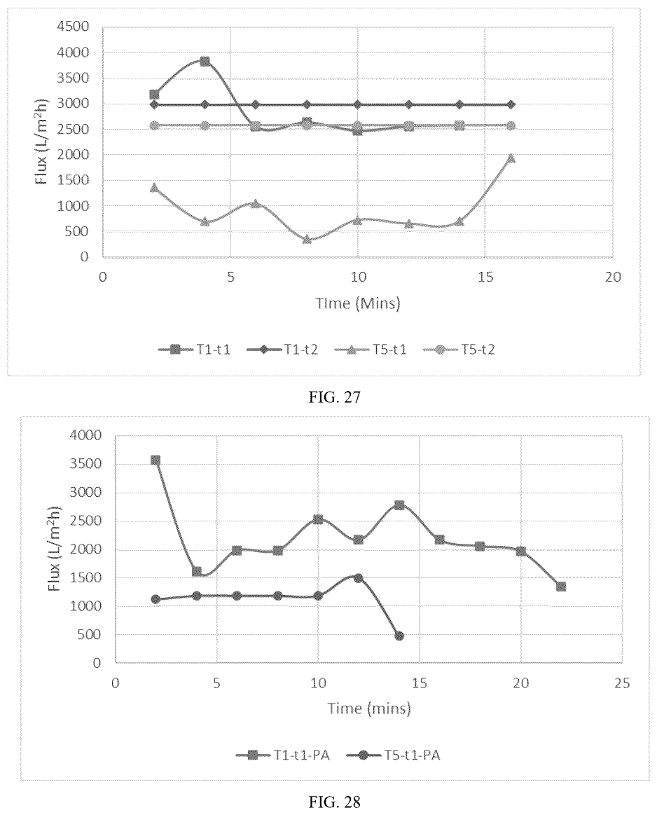

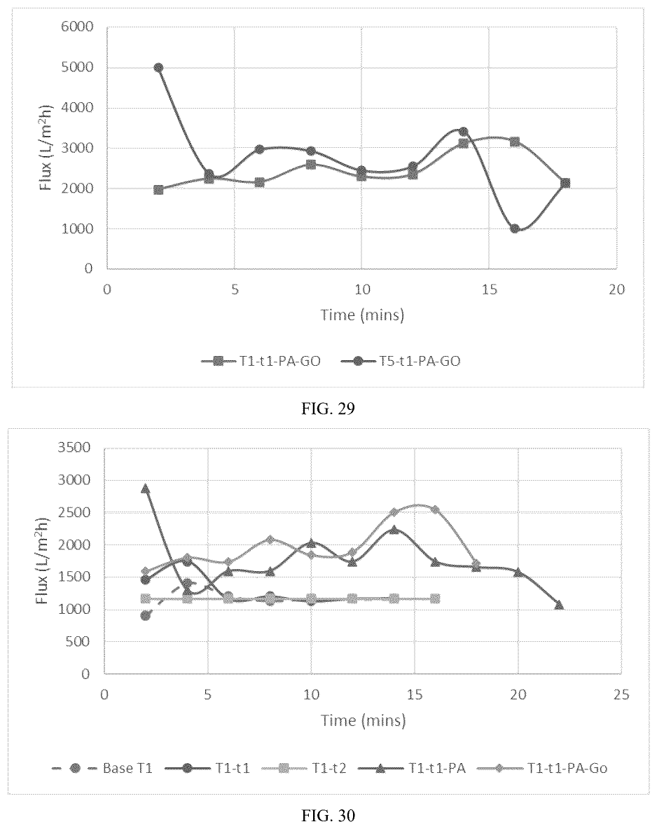

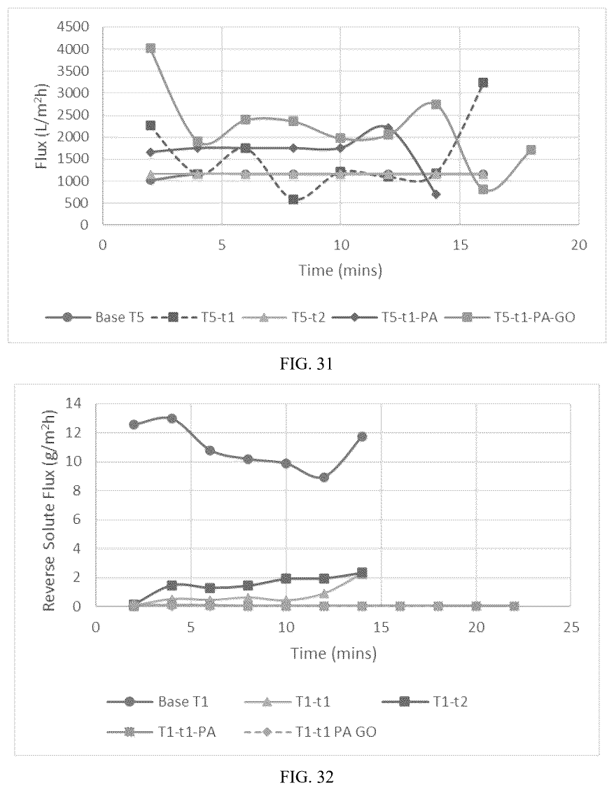

As presented in FIG. 26 and FIG. 27, the PES-based and PSF-based NFM hot-pressed samples (T1-t1 and T5-t1) demonstrated improvement in water flux, relative to the original NFM samples (T1 and T5). Without being bound to any theory, this is because during the hot-press treatment, the membrane pore size became smaller and pore size distribution became narrower. The interconnected fibrous architecture of the modified substrate membranes with high porosity facilitated the mass transfer of water. Moreover, FIGS. 28-31, showed that the water flux values were considerably improved with the deposition of the PA layer and the GO-PA layer on the top of the hot-pressed NFM samples.

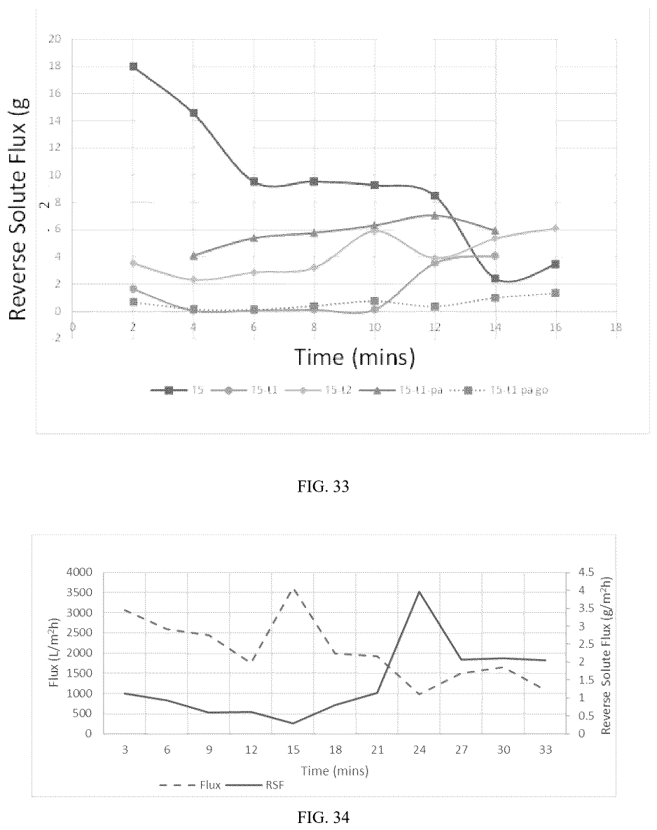

Similarly, FIG. 32 and FIG. 33 showed that the reverse solute flux (RSF) of the hot-pressed NFM samples were almost close to zero. For the original nanofiber samples (T1 and T5), the pore sizes were much higher, allowing the passage of salts, and hence the reverse salt flux values were higher initially. The average RSF values of the original nanofiber samples T1 and T5 were almost 11 g/m² h and 8.5 g/m²h, respectively. This clearly confirms that the original nanofiber samples without any treatment may be difficult to use in the FO process. On the other hand, with the hot-press treatment at 150° C., the RSF values of T1-t1 and T5-t1 exponentially decreased with average values of 2 g/m² h and 1 g/m²h, respectively. It was observed that with the hot-press treatment, the pore size reduces, thus restricting the passage of salts, and hence exponentially reduces the reverse solute flux. Furthermore, with the deposition of the polyamide layer, samples T1-t1-PA and T5-t1-PA demonstrated lower reverse solute flux, almost close to zero. Further, the GO-incorporated polyamide samples T1-t1-PA-GO and T5-t1-PA-GO attained ideal FO membrane working conditions.

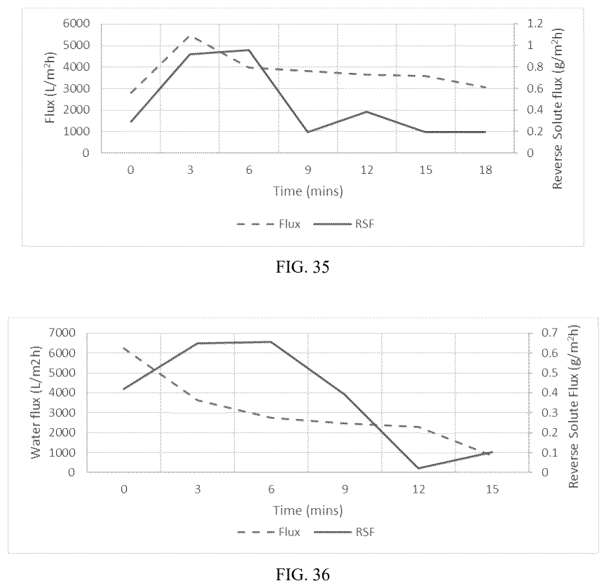

The water flux and RSF of PES-based T1-t1 sample showed good FO performance tested using higher feed volume, even after the membrane was stored in dry condition for a longer period of 90 days (FIG. 34). The water flux and RSF of the T1-t1-PA membrane, which was stored for a period of 90 days in dry state, performed well when carried out in an FO experiment using higher feed volume (5000 mL) and high feed concentration (FIG. 35). This high-salinity experiment was performed using the draw solution with conductivity 135 mS/cm (total dissolved solids (TDS) value—74250 mg/L) and feed solution with conductivity 210 mS/cm (TDS value-115500 mg/L). Moreover, the water flux and RSF of T1-t1-PA membrane, which was stored for a period of 90 days in wet state, performed well when carried out in an FO experiment (FIG. 36). The storage condition of the membrane developed as described herein does not affect its FO performance.

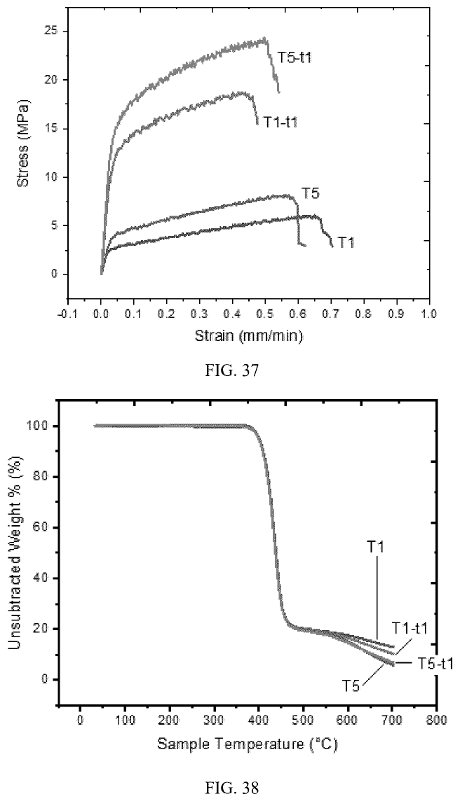

Table 3-4 presents the mechanical strength of PES-based and PSF-based NFMs in terms of Young's modulus, tensile strength and elongation at break, before and after the hot-press treatment process. The mechanical properties are enhanced significantly after heat treatment (FIG. 37). The PES-based sample T1 and PSF-based sample T5 showed an increase in tensile strength of almost 3-fold with 150° C. hot press treatment for 10 minutes. Moreover, the sample T1 showed an increase in the value of Youngs modulus of 3-fold and T5 showed an increase in the values of Youngs modulus of 4.5-fold with 150° C. hot press treatment for 10 minutes. This trend showed that hot pressing under 0.5 tons/m² load at temperatures 150° C. significantly increased the fiber strength. This improvement in the mechanical strength is due to the fusion of the polymeric nanofibers on the top and bottom surfaces of the membrane. Also, without being bound to any theory, this higher value for the mechanical property could be explained by the dense packing of the nanofiber layers and the inter-nanofiber interactions. The tensile testing proved that the membrane specimens demonstrated an increase in tensile strength of three-fold with hot press treatment at 150° C. temperature for 10 minutes under 0.5 tons/m².

TABLE 3-4
Mechanical properties of PES-based PSF-based NFMs perpared as per the
present invention, before and after hot-press post treatment process

| | Tensile | | Young's | Hot | Tensile | | Young's |
|---|---|---|---|---|---|---|---|
| Base | Strength | Stiffness | Modulus | Pressed | Strength | Stiffness | Modulus |
| Samples | (Mpa) | (N/mm) | (Mpa) | Samples | (Mpa) | (N/mm) | (Mpa) |
| T1 | 6.17 | 49.08 | 172.10 | T1-t1 | 21.01 | 62.39 | 536.25 |
| T5 | 8.2 | 46.192 | 190.41 | T5-t1 | 24.63 | 86.192 | 867.192 |

As shown in FIG. 38, the TGA of hot-pressed NFM samples showed the same thermal stability relative to original PES-based and PSF-based NFMs. This confirms that the hot-press treatment at the specific conditions according to the current invention will not have any impact on the thermal stability of the heat-treated nanofiber membranes.

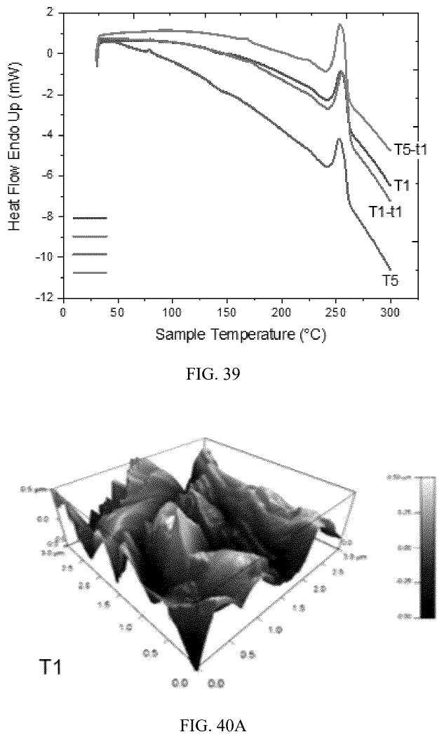

Moreover, as presented in FIG. 39, the DSC of hot-pressed NFM samples confirmed that hot-press treatment at the specific conditions had negligible impact on the nanofiber crystallization; the peaks of the endothermic curves of base samples T1 and T5 are similar to those of T1-t1 and T5-t1. This confirms that there is very little to no crystallization with heat treatment. Furthermore, it shows that heat treating the polymer nanofibers has negligible effect on the fiber crystallization.

The AFM analysis of the nanofiber membrane base samples and hot-pressed samples shows that hot-press treatment at the specific conditions has an affect on the surface roughness of the nanofiber membrane samples (FIGS. 40A-40D and Table 3-5). For sample T1, the RMS value was 242.986 nm. However, for the corresponding hot-treated sample T1-t1, the roughness value was in the range of 56.051 nm. Similarly, the RMS value of T5 sample changed from 94.086 nm to 49.601 nm after hot-press treatment. The lower values of T1-t1 and T5-t1 shows that the surface become smoother subsequent to hot-press treatment relative to the base samples. Generally, the RMS values for majority commercial and lab synthesized polyamide membranes are in the range of 50 nm. Thus, the AFM analysis established that the surface became very smooth after hot-pressing, and the membrane surface will experience less fouling relative to un-pressed samples.

TABLE 3-5
Surface roughness values of samples PSF-based
NFMs before and after heat treatment process

| Samples | RMS (nm) |
|---|---|
| T1 | 242.986 |
| T1-t1 | 56.051 |
| T5 | 94.086 |
| T5-51 | 49.61 |

SEM images of nanofiber membrane base and hot-pressed samples are shown in FIG. 41A and FIG. 41B. The morphologies of PSF-based NFM changed following hot-press treatment. From the images, it is apparent that defective fibers with beads and ribbon-like structure were noted in T5 due to the incomplete evaporation of solvent from the jet surface. Nevertheless, with the hot-press-treatment, partial fiber fusion might have occurred, leading to an inter-fiber welding at fiber crossover points, which results in membrane structural integrity. This nanofiber fusion was also seen in the tensile testing results, which resulted in improved mechanical properties. Furthermore, the SEM images showed a reduction in the pore size of the nanofibers subsequent to the hot-press treatment. Therefore, the hot-press treatment could reduce the pore size, which would be very advantageous for numerous applications of NFMs like water treatment.

As shown in FIG. 42, the Young's modulus of hot-press treated T1-t1 and T5-t1 samples observed from the tensile testing analysis are in line with the storage modulus values seen from the DMA analysis. The storage modulus of original NFMs increased (T1 from 74.6294 MPa to 144.45 MPa and T5 from 110.012 MPa to 143.482 MPa) after the hot-press treatment under 0.5 tons/m² load for 10 minutes at a temperature of 150° C.

The hydrophilicity of PES-based and PSF-based nanofiber membrane samples, hot-pressed samples, PA and GO-PA deposited nanofiber samples were examined by the contact angle analysis. A super hydrophilic behavior was noted for the NFMs after the deposition of PA and PA-GO layers. The contact angles of original T1 and T5 were 126° and 133° respectively. However, following the hot-press treatments and PA layer/PA-GO layer depositions on the PSF and PES-based NFMs, the contact angle values decreased drastically, such that it was difficult for the equipment OCA35 system to capture and measure the contact angles using the sessile dope method (results not shown). During the hot-pressing, more fibers fused at interlay points, which could contribute to both reduced pore sizes as well as an improved mechanical strength, as noted from tensile testing analysis. Subsequently, the PA and PA-GO layer deposition takes place on the hot-pressed membranes evenly, such that the water molecules can pass through very easily. This super hydrophilicity also resulted in super-fast water flux during the FO performance testing.

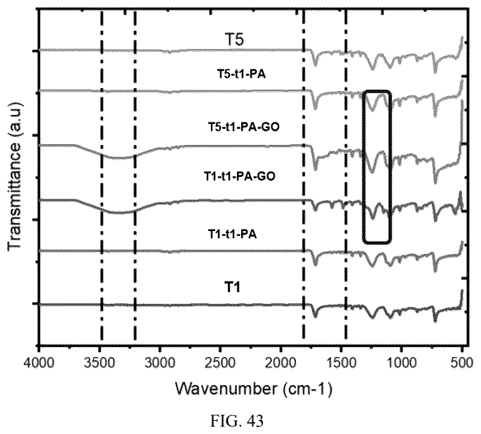

FIG. 43 presents the FTIR spectra for PES-based and PSF-based nanofiber membrane samples, hot-pressed polyamide deposited NFM samples, and hot-pressed GO-polyamide deposited NFM samples. The absorption peaks ranging from 1500 cm⁻¹ to 1700 cm⁻¹ correspond to the aromatic C—H stretching present in the polymeric matrix. The vibrational peaks ranging from 1300 cm⁻¹ to 1500 cm⁻¹ are mainly due to the aromatic C═C bond stretching in PA units present in samples T1-t1-PA, T1-t1-PA-GO, T5-t1-PA and T5-t1-PA-GO (marked with black square). Moreover, the broad peak at 3442 cm⁻¹ corresponds to the oxygen-carbon bond vibrations, and confirms the presence of GO in samples T1-t1-PA-GO and T5-t1-PA-GO. Thus, the FTIR spectra confirmed the presence of PA and GO in the NFM samples.

It will be obvious to those skilled in this nanofiber membrane field that numerous changes as well as adjustments could be done in the present invention, without deviating from the scope of the current invention. Other illustrations of this invention would be clear to those experts in the field of membranes, from understanding the specification and practice of the current invention stated here. It is anticipated that the example as well as specification be interpreted as just a standard, with an actual scope of this invention being identified by the following claims.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed is:

1-17. (canceled)

18. A thin-film nanocomposite (TFNC) membrane prepared by a method comprising steps:
a. preparing a spinning solution by mixing 5 wt % to 30 wt % by weight of the solvent of either (1) polysulfone with N-dimethyl formamide (DMF) or (2 polyethersulfone with N-methyl-2 pyrrolidone/toluene in a 2:1 ratio;
b. feeding the polymer solution of (1) or (2) into a SBS system using a concentric nozzle to produce solution blown fibers;
c. collecting the polymeric nanofibers evenly on a rotating vacuum collector to obtain a nanofiber mat on a polyester backing layer;
d. hot-press post-treating the polymeric nanofiber membranes by positioning the membranes between a set of steel plates at 150° C. for 10 minutes or 175° C. for 6 minutes under a low loading of 0.5 tons/m²;
e. removing the steel plates from the hot-press and cooling the steel plates;
f. removing the polymeric nanofiber membrane samples from the steel plates; and
h. preparing either (1) a trimesoyl chloride solution and a m-phenylenediamine solution or (2) a m-phenylenediamine graphene oxide solution; and either (ia) or (ib):
ia. preparing the thin-film composite membranes by depositing a polyamide layer on top of the polymeric nanofiber membranes by an interfacial polymerization process using the trimesoyl chloride solution and a m-phenylenediamine of step (h); or
ib. preparing the thin-film nanocomposite (TFNC) membrane by depositing a graphene oxide-incorporated polyamide layer on top of the polymeric nanofiber membranes via an interfacial polymerization process using the m-phenylenediamine graphene oxide solution of step (h).

19. A thin-film nanocomposite (TFNC) membrane prepared according to claim 18, wherein the membrane shows no indication of practical fouling or decline in performance after 90 days of storage.

20. A thin-film nanocomposite membrane prepared according to claim 18, wherein the membrane is capable of extracting water during a forward osmosis process from low concentration feed solution to high concentration draw solution in DI water or high-concentrated industrial brine solution.

21. A thin-film nanocomposite membrane prepared according to claim 18, wherein the membrane exhibits the high water flux and low RFS values according to FIG. 34, FIG. 35, or FIG. 36.
